(19) United States
(12) Patent Application Publication
(10) Pub. No.: US 2014/0201620 A1
(43) Pub. Date: Jul. 17, 2014

(54) METHOD AND SYSTEM FOR INTELLIGENT WEB SITE INFORMATION AGGREGATION WITH CONCURRENT WEB SITE ACCESS

(71) Applicant: WEBEZO INC., Sunnyvale, CA (US)

(72) Inventors: Rahul Khona, Sunnyvale, CA (US); Dayanand Reddy Pochugari, Sunnyvale, CA (US); Dennis Berko, Sunnyvale, CA (US); Michael Hexner, Sunnyvale, CA (US)

(73) Assignee: WEBEZO INC., Sunnyvale, CA (US)

(21) Appl. No.: 14/156,335

(22) Filed: Jan. 15, 2014

Related U.S. Application Data
(60) Provisional application No. 61/752,547, filed on Jan. 15, 2013.

(51) Int. Cl. G06F 17/30; G06F 17/22

(52) U.S. Cl. CPC G06F 17/30864; G06F 17/2247; G06F 17/30554
USPC 715/234; 707/723; 707/706

(57) ABSTRACT

An intelligent web site information aggregation method and system is disclosed. Embodiments automatically extract information form a web page being currently viewed. A search query is formulated based on the extracted information. Web pages that have been returned in previous searched an also be merged with information extracted from the current page to formulate a search query. The user can specify disliked items as well as desired items. The user can specify preferences that are saved for later searches. A user interface displays webpages that have been found as well as the current page for side-by-side comparison. Users can share search results with others so that collaborative shopping can occur.

### BACKGROUND

Search engines and data aggregators are in wide use today. Current methods for Internet searching and aggregation of Internet data have some disadvantageous characteristics. For example, Internet shopping aggregation returns a large number of search results produced by search engines are not relevant to what the user is looking for. Reasons for this include the fact that website owners take advantage of page ranking algorithms of search engines and use search engine optimization (SEO techniques) to acquire top spots, and as a result pages that have higher SEO value can be returned before the pages that are more relevant to the user's search. In addition, it is very difficult for users to build queries that avoid unnecessary results. Users rely on simple keyword searches to find results that include all the pages that contain one or more keywords typed. Some of the difficulties faced by users writing queries include: inability to specify negative criteria (that is, inability to prevent return of results that contain specified keywords); and inability to specify ranges of values for (for example “find me all the TVs that have a 42″ to 48″ screen size, and/or cost between $10,000 and $15,000).

Currently, when a user is viewing a particular page from any arbitrary website, they are unable to concurrently find other pages on the Internet that are similar to the page they are currently viewing. There are tools available to facilitate similar searches. However, for website pages to appear in these searches, they must be among a group of web pages for which the software tools (or application) were specifically written. In order perform such searches for any arbitrary websites, users must open a new tab or window, go to a search engine page and search again with keywords they think would result in finding similar pages from other sites. This is unsatisfactory at least because: users get irrelevant results; users are taken away from the current page onto the “new” search engines results page; and the search is static and does not take into account their previous searches.

When a user is viewing a particular page, he or she does not now have an easy way to compare pages from their previous search and a current search side-by-side. Instead, the user would have had to previously bookmark each page visited, open several windows, and in each of these windows open a page from previous bookmark to compare. Internet users often visit multiple pages but forget to bookmark the pages. They also forget the query they used to find a page, and so are often unable to quickly find desired previous pages.

Internet shoppers don't presently have an easy way to make meaningful notes for the products they have seen during their research phase that would be useful during their decision making process. Also, Internet users don't have an easy way of associating a set of web pages with each other and viewing them side-by-side at a later time during the decision or research process. For example, there is no way to easily associate school district information the user found with results of the user's housing search.

Internet users often want to receive the opinions of their friends and family before making a buying decision. Current search engines don't offer an easy way for Internet shoppers to share their search results with friends and ask for opinions. Shopping aggregation sites offer the functionality but are restricted to pages within their own sites, while most users look at products and services from multiple sites before making a purchase.

Current search engines do not remember a user's previous searches or allow the user to resume a search from the same point in subsequent sessions.

Users often search online as well as offline. Current search engines do not have a way to track a user's offline searches.

Current search engines tend to return the same results over and over again for the same query and do not allow the user to reject the results they are not interested in seeing.

### BRIEF DESCRIPTION OF THE DRAWINGS

FIG. 1 is a block diagram of a system for intelligent web site information aggregation with concurrent web site access according to an embodiment.

FIG. 1A is a block diagram of a system architecture for intelligent web site information aggregation with concurrent web site access according to an embodiment.

FIG. 1B is a block diagram of a system architecture for intelligent web site information aggregation with concurrent web site access according to an embodiment.

FIG. 1C is a block diagram of a system architecture for intelligent web site information aggregation with concurrent web site access according to an embodiment.

FIG. 1D is a block diagram of a system architecture for intelligent web site information aggregation with concurrent web site access according to an embodiment.

FIG. 1E is a block diagram of a system architecture for intelligent web site information aggregation with concurrent web site access according to an embodiment.

FIG. 1F is a block diagram of a system architecture for intelligent web site information aggregation with concurrent web site access according to an embodiment.

FIG. 2A is a flow diagram illustrating a web page search process executed by system processors according to an embodiment.

FIG. 2B is a flow diagram illustrating a web page search process executed by system processors according to an embodiment.

FIG. 2C is a flow diagram illustrating a web page search process executed by system processors according to an embodiment.

FIG. 3A is a flow diagram illustrating a web page search process executed by system processors according to an embodiment.

FIG. 3B is a flow diagram illustrating a web page search process executed by system processors according to an embodiment.

FIG. 3C is a flow diagram illustrating a web page search process executed by system processors according to an embodiment.

FIG. 4A is a flow diagram illustrating a web page search process executed by system processors according to an embodiment.

FIG. 4B is a flow diagram illustrating a web page search process executed by system processors according to an embodiment.

FIG. 4C is a flow diagram illustrating a web page search process executed by system processors according to an embodiment.

FIG. 5A is a flow diagram illustrating a web page search process executed by system processors according to an embodiment.

FIG. 5B is a flow diagram illustrating a web page search process executed by system processors according to an embodiment.

FIG. 5C is a flow diagram illustrating a web page search process executed by system processors according to an embodiment.

FIG. 6A is a flow diagram illustrating a web page search process executed by system processors according to an embodiment.

FIG. 6B is a flow diagram illustrating a web page search process executed by system processors according to an embodiment.

FIG. 6C is a flow diagram illustrating a web page search process executed by system processors according to an embodiment.

FIG. 7A is a flow diagram illustrating a web page search process executed by system processors according to an embodiment.

FIG. 7B is a flow diagram illustrating a web page search process executed by system processors according to an embodiment.

FIG. 7C is a flow diagram illustrating a web page search process executed by system processors according to an embodiment.

FIG. 8A is a flow diagram illustrating a web page search process executed by system processors according to an embodiment.

FIG. 8B is a flow diagram illustrating a web page search process executed by system processors according to an embodiment.

FIG. 9A is a flow diagram of a process for the title in a web page that best describes the item under consideration according to an embodiment.

FIG. 9B is a flow diagram of a process for the title in a web page that best describes the item under consideration according to an embodiment.

FIG. 10A is a flow diagram describing a method of finding a best price on a web page according to an embodiment.

FIG. 10B is a flow diagram describing a method of finding a best price on a web page according to an embodiment.

FIG. 11A is flow chart illustrating a like-dislike search process according to an embodiment.

FIG. 11B is flow chart illustrating a like-dislike search process according to an embodiment.

FIG. 12A is a flow diagram of a process for allowing a user to compare the current web page that he or she is viewing side-by-side with other pages from the Internet according to another embodiment.

FIG. 12B is a flow diagram of a process for allowing a user to compare the current web page that he or she is viewing side-by-side with other pages from the Internet according to another embodiment.

FIG. 13 is a flow diagram a process for allowing a user to attach web pages that they are viewing to other web pages on the Internet.

FIG. 14-FIG. 17 are screenshots that show a user interface displayed by the system according to an embodiment.

### DETAILED DESCRIPTION

Embodiments of the invention improve upon current Internet searching and shopping experiences. Aspects of various embodiments include the ability to find pages similar to the currently viewed page from any arbitrary website available on the Internet; not just a subset of sites for which an application is specifically written. Aspects further include the ability to show the results alongside the current page without the user having to navigate away from the current page. The user is also able to compare the current page that a user is viewing side-by-side with other pages on the internet. The user can compare other pages in their search history side-by-side with the currently viewed page. Embodiments allow users' preferences to be automatically detected. This includes detecting user preference regarding items currently being searched for, and automatically formulating queries to find similar pages based on the preferences, the current page, past pages viewed, and explicit preference criteria provided by the user. Embodiments also allow the user to attach an arbitrary web page to the web page they are currently viewing, so they can retrieve all the pages together during subsequent reference to the page. Embodiments also include finding Internet pages related to the current page the user is viewing. For example, the user can find school district scores while viewing a web page containing a house for sale.

According to an embodiment, when two internet pages are found for the same or similar products, this is automatically determined. It is also automatically determined whether the two pages match with the user's preference or not.

Algorithms of various embodiments perform useful functions including: detecting the title of the product from a given web page out of several headings in a page; detecting the physical address associated with a web page; detecting the offered price for the product from several prices listed on a page; determining the category of the product; and automatically detecting dislikes based on the pages reject by the user.

Embodiments of a user interface include a search box that includes both “liked” and disliked keywords, as opposed to a simple search box for liked keywords. Embodiments of the user interface also include a mechanism to view pages from different websites side-by-side to aid in comparison of products. The user further has the ability to rank the attractiveness of the pages, thus enabling better detection of user preferences from analysis of these pages. A search can be restarted search from a previous point. Continuous search is also possible.

In various embodiments, indexing of sites is available on demand. In addition, a user can select and click to specify likes and dislikes for a given page, in order to enhance the criteria for finding similar products. A user can reject a search result by clicking a button to further specify dislikes. In an embodiment, previously rejected search results are not presented to the user.

Embodiments include a drag-able bookmarklet and plugin that the user can place anywhere on the screen.

In yet another aspect of the claimed invention, a page currently being viewed by the user can be attached to another page on the internet that the user has already seen.

According to and embodiment, the user views a current page, while associated pages are also presented. Associated pages are selected based on pages associated with the user as well as based on searches done by the system in the background (e.g. showing all the surrounding restaurants on a hotel page or showing school district scores for the house being viewed). Once a user feels he or she has completed a search, the user can mark the search “complete” and also identify items chosen from the search.

Aspects of the claimed invention provide highly relevant Internet results that match users' desires. Users are enabled to employ list of keywords desired to be present on the pages that are returned by search. This is expanded to automatically reject pages that contain negation on these keywords, for example if a user enters “automatic transmission” in the likes and the page contained “no automatic transmission” or “automatic transmission not available”

Users can also employ a list of keywords that would result in pages being not returned if the words are contained in them. This is expanded to automatically accept pages that negate the words, for example if a user specified “Linux” as a dislike keyword, pages that contain “No Linux” or “Linux not available” are automatically accepted.

In an embodiment, the user can employ various numeric ranges of key metrics associated with the items to specify a range, such as “find me cars between $10,000 and $20,000 or TVs between 42″ and 48″ inch screen”.

Users also are provided with 1 click or always-automatic access to pages on the Internet similar to the page they are currently viewing, are highly relevant to what they are currently looking at, and have been recently viewed. Embodiments detect what a page is about and what pages we should look for. For example, the title of the page is detected using html analysis techniques that look for most relevant keywords. Common English words are ignored in order to generate most relevant results. Prices associated with the page are detected using various lexical and html algorithms. Various other numeric attributes that define various types of measurements for the product are also detected. Also detected are other key attributes associated with the specific products/services/jobs to identify the category of the product sought. The list names created by various users in the current system are matched against the title of the page to help further define the category. Products/services/jobs viewed/liked previously by the user that belong to the same category and expand the ranges between minimum and maximum for the products are considered in formulating search criteria. Also considered are repeated words in the titles; higher weight is given to repeated words to produce higher relevancy. Also considered are products/services/jobs added by other users in the same category. In an embodiment, higher weight is assigned to products added by people that have added the same products in their list as the current user. Users can also identify or specify and address/zip code on the site to locate products.

Once all these criteria (any criteria entered by the user—it need not be all of the criteria listed above) are calculated, a search query is formulated taking into account these criteria. The results that are generated are then filtered, including rejecting pages that have dislikes or negated likes.

Embodiments of the invention provide an easy way to compare products and services from different sites side-by-side. Users can compare the current page they are viewing with other similar pages from their search history. The system maintains a continuous search that remembers users' search preferences, searches for them in the background, and also resume from the previous point without having user to specify the search query again.

Embodiments provide an easy way for users to not only specify things they would like to see in the pages but also things they would like not to see, thus resulting in much higher relevancy of their results. Viewed pages are automatically memorized, or alternatively the user can 1-click pages for memorization. Visited pages are automatically tracked, which enables the system to notify users of price changes or unavailability of a specified product or service.

Users can share the items they are viewing/considering with other users and enable their friends to vote on the items, as well as recommend other items that the user should consider. In an embodiment, information in the Internet that is associated with viewed items is automatically added to a record of the information that is viewed. Users can also manually attach related/associated information with the page they are viewing for future reference. Users can also restrict their results from/to specific sites, or restrict search results to specific zip codes only. This is very useful for big-ticket items, real estate, jobs etc.

Embodiments include co-browsing, which allows friends to browse and shop for things together, facilitating real-time collaboration during searches.

Embodiments employ on demand indexing and page analysis to save storage costs.

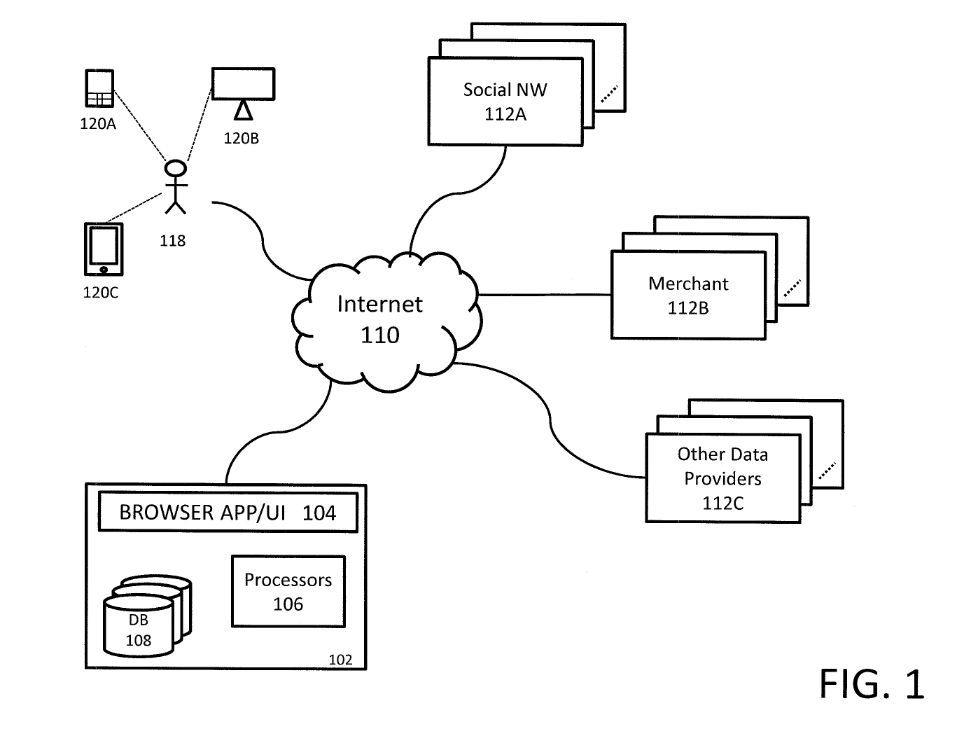

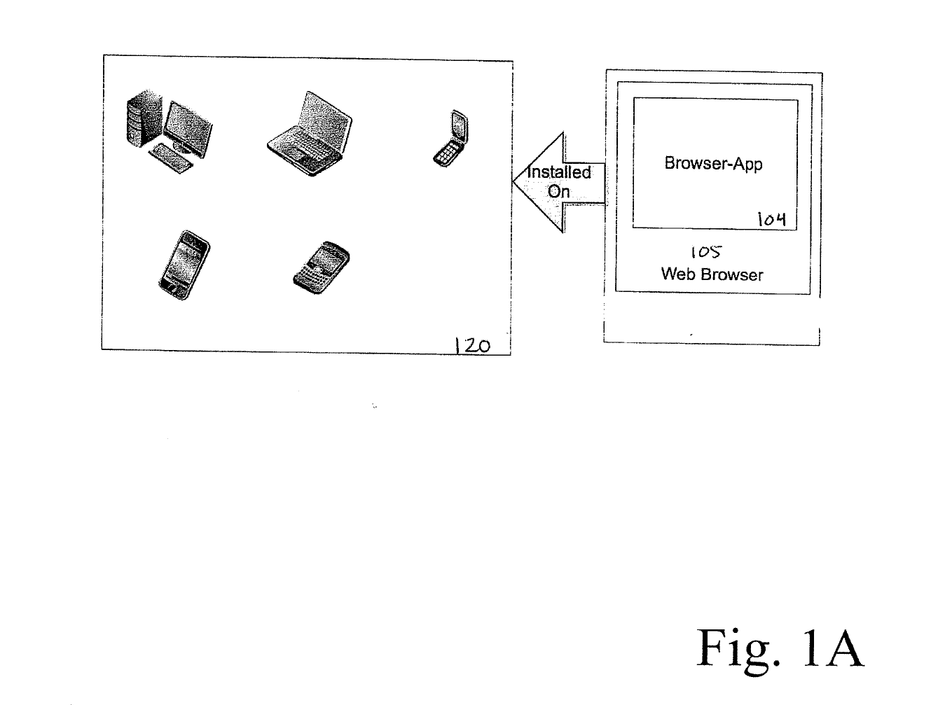

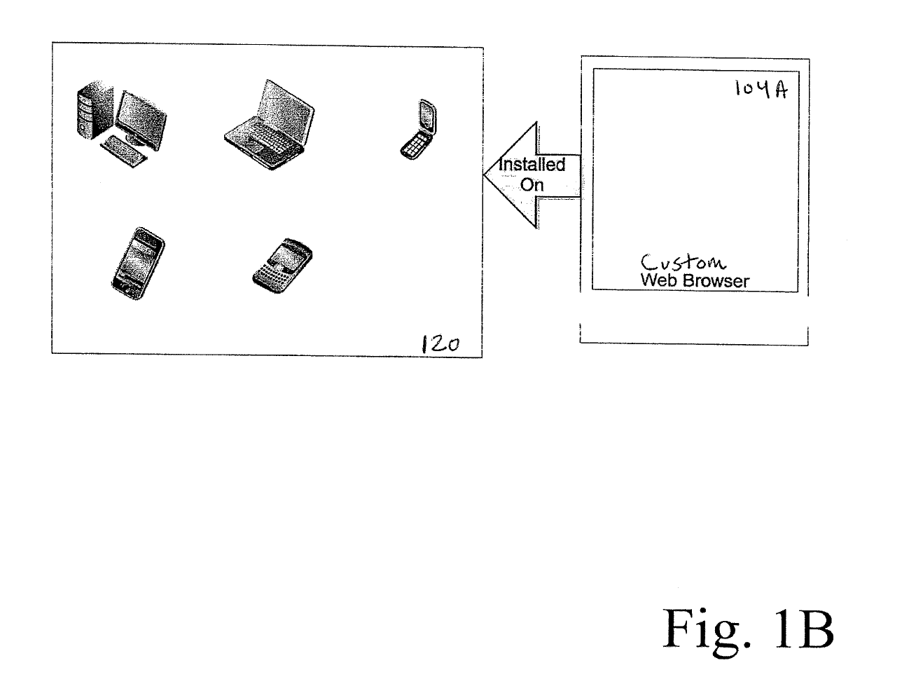

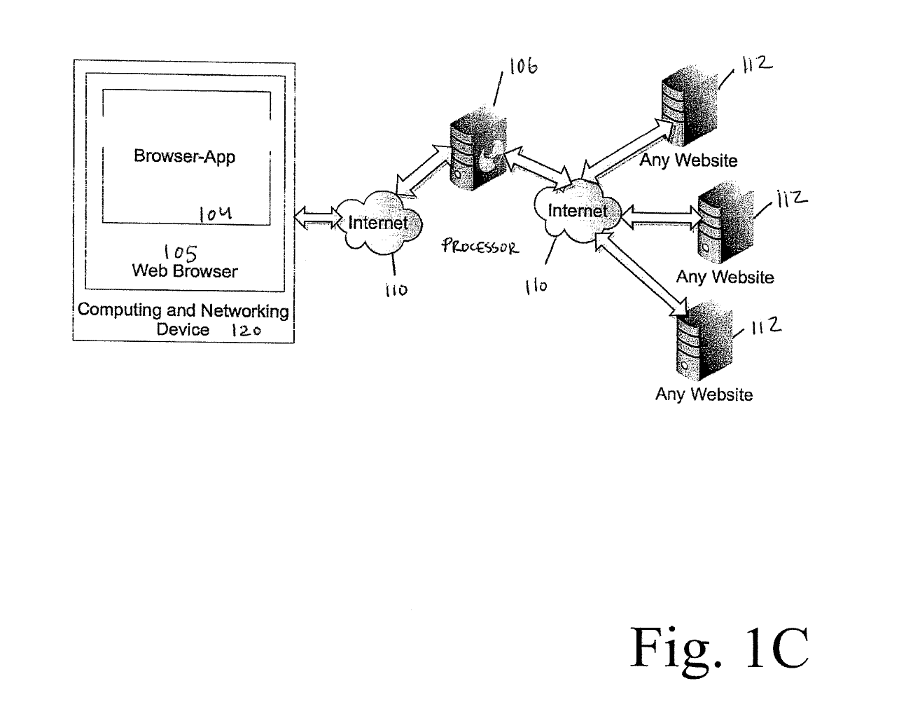

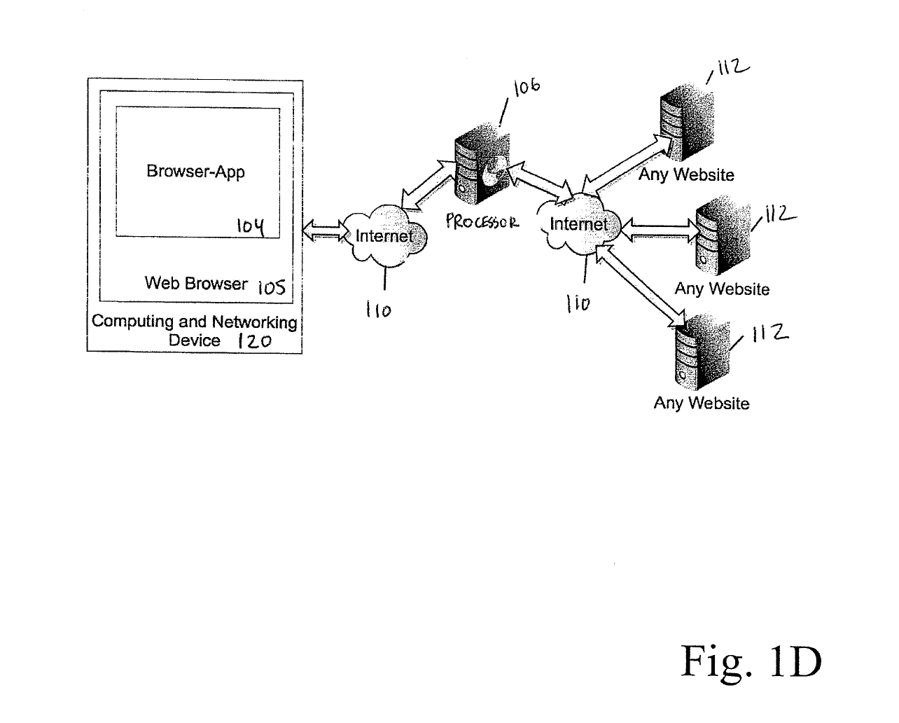

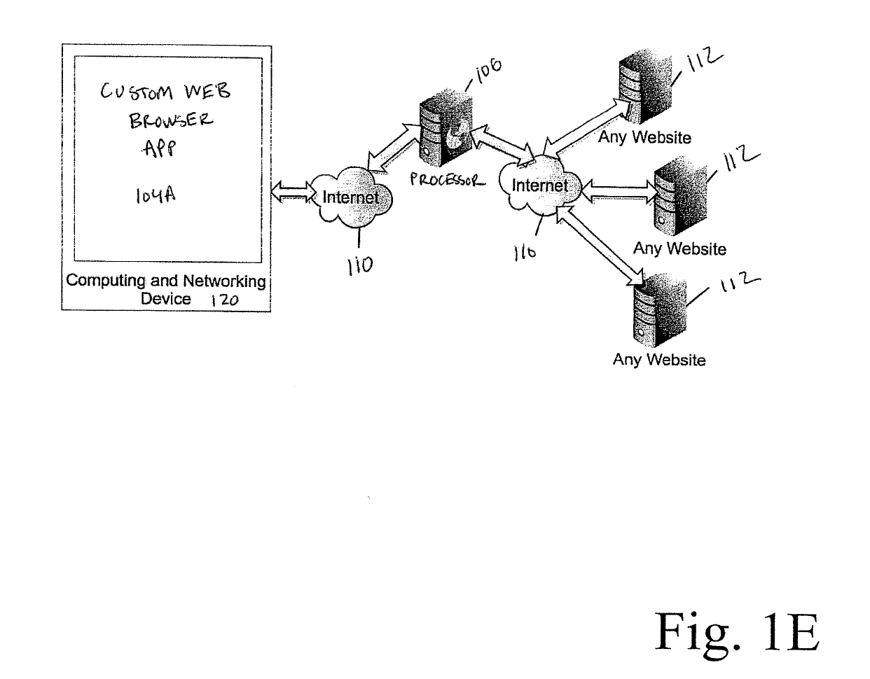

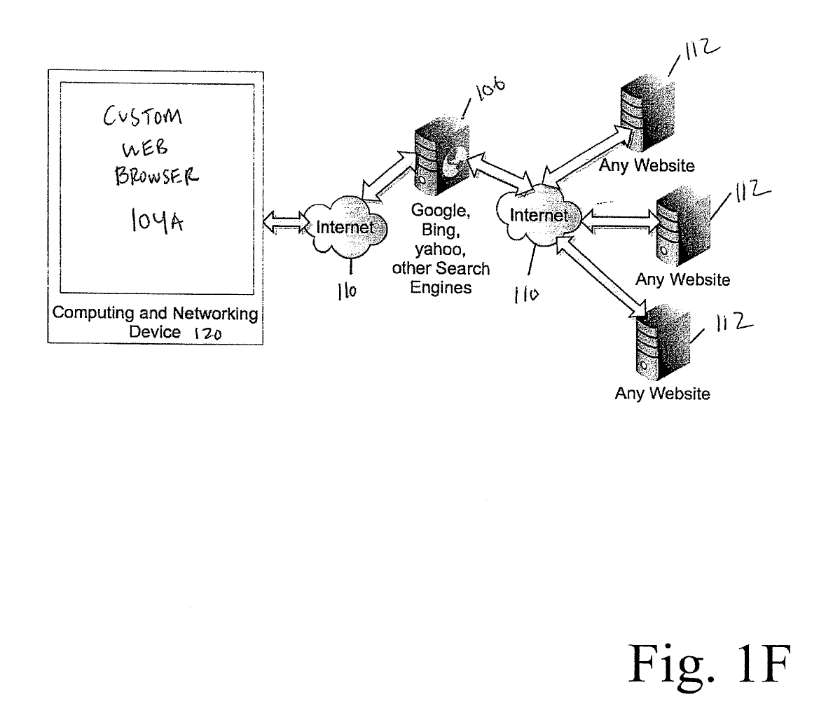

FIG. 1 is a block diagram of a system 102 for intelligent web site information aggregation with concurrent web site access according to an embodiment. Embodiments of the invention include a browser application 102 (which encompasses a bookmarklet or a browser add-on, referred to herein as a browser app) that is downloaded onto a user 118 computing device 120 such as a computer 120B, a smartphone 120A, a tablet 120C, etc. and is installed in any of the popular browsers 105 such as Internet Explorer™ (IE™), Firefox™, Chrome™, Opera™, Safari™ etc. FIG. 1A is a block diagram illustrating such an embodiment.

FIG. 1B is a bock diagram of an embodiment of the system in which a custom web browser/browser app 104A is downloaded and installed on the computing devices 120 to perform the processes described herein. As further described below, the browser apps 104 monitor the pages visited by the user and find similar Internet pages in order to help the user quickly find goods, services, real-estate, jobs or any other item that best meet the user's needs and preferences.

The browser app 104 is hosted and maintained by system 102, which also includes processors 106 and databases 108. As shown below, the system 102 can also be distributed across any network in any manner. System 102 communicates via the Internet 110 with online merchants 112B. System 102 also communicates with other data providers 112C, which includes any source of online information, including but not limited to, sources of product reviews and pricing information. System 102 further communicates with multiple social networks 112A as further described below to facilitate a shared browsing/shopping experience.

Without intending to limit the invention as claimed, the system can generally operate using one of at least three methodologies. In one methodology, as illustrated in the block diagram of FIG. 1C, the browser app delegates the task of analysis of a web page and building a search query (to find similar pages) to a processor 106 residing on the Internet as shown in FIG. 1C. Processors 106 communicate with various web sites 112 via the Internet 110.

In one methodology the browser app 104 itself performs the analysis of the web page and builds a search query for finding the similar pages. FIG. 1D is a block diagram of an architecture supporting such a methodology. FIG. 1D also illustrates the use of various Internet search engines 111.

FIGS. 1E and 1F are block diagrams illustrating the above two methodologies when the custom web browser 104A is used as the web browser/browser app.

In yet another embodiments using a third methodology, the user submits web pages to a website where the algorithms of the browser app 104 run and perform the task of finding similar pages from the Internet to the page submitted by the user.

The browser app 104 itself can operate in at least two modes. In one mode the user activates the browser app 104 to find pages from the Internet similar to pages he or she is viewing by explicitly invoking the browser app 104. The browser app 104 is invoked by either clicking a button or an icon, or by swiping gesture on a mouse, track pad or other input devices available on computing devices 120.

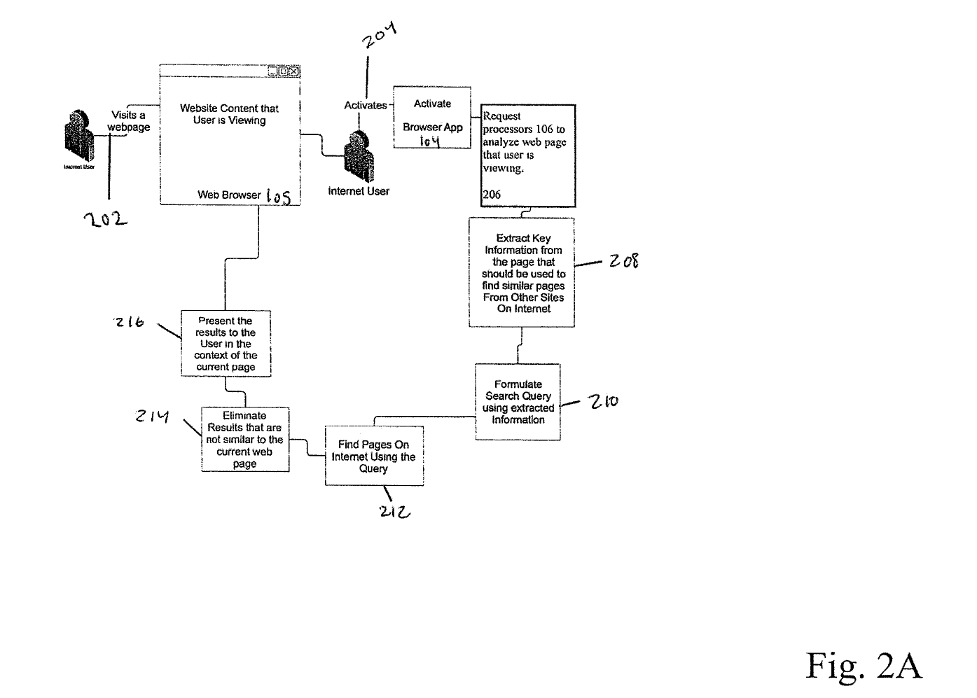

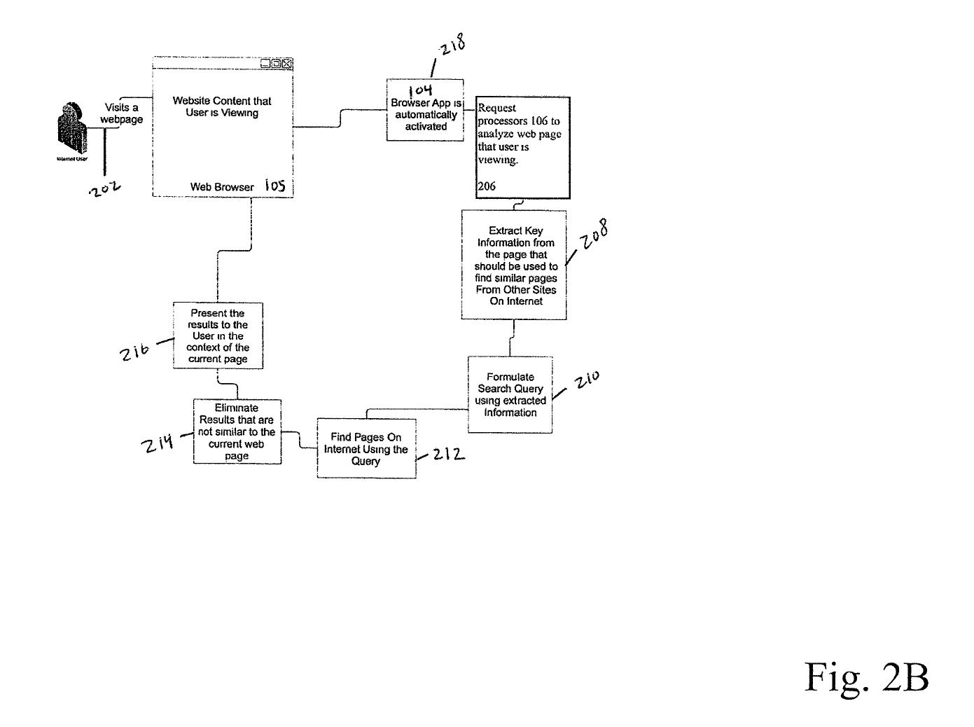

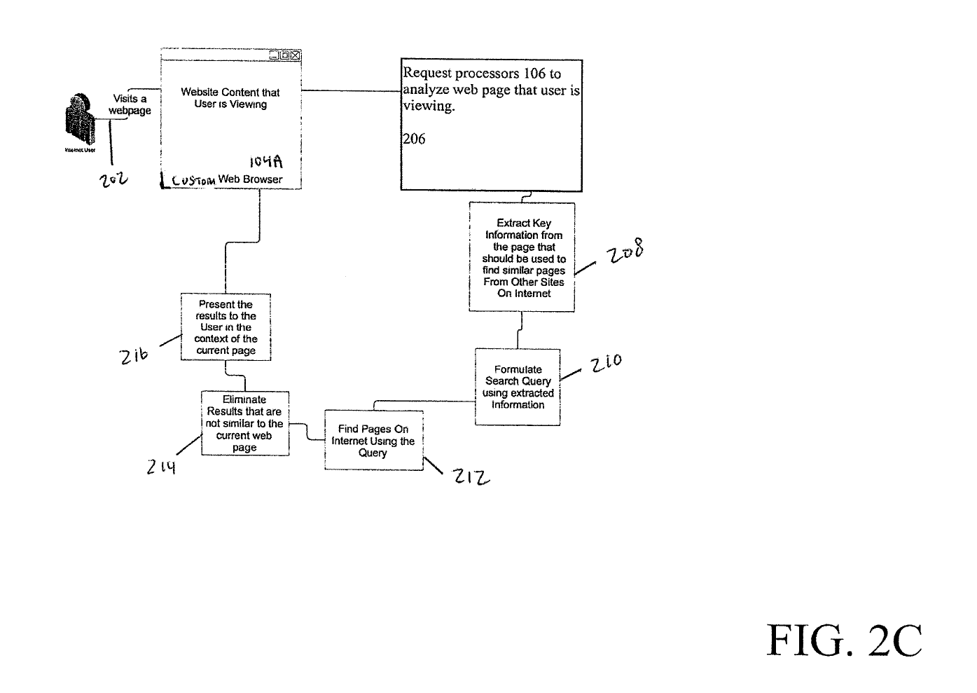

FIG. 2A is a flow diagram illustrating a web page search process executed by the processors 106 according to an embodiment. At 202, the user is logged onto the Internet and using a web browser 105. When the user activates (204) the browser app 104, the browser app 104 automatically submits either the URL of the current web page or the contents of the current web page with a request for processors 106 to analyze the web page (206). Processors 106 extract (208) key data for the web page, where the information is used to finding similar pages from other (and possibly the same) sites on the Internet. This involves the processors 106 analyzing the web page, including include analyzing the textual content of the page, analyzing the visual layout (such as position and size of various elements in the page) to find key elements that describe the item being shown on the page. Elements include, but are not limited to:
Title of the page;
Title or heading describing the product;
Price of the product;
Any discounts of special offers associated with the product;
Various numeric measures that are used to describe the product for (e.g. dimensions, weight, power consumption, efficiency, fuel consumption, years of experience, target age group, etc.);
Various non-numeric measures (such as Used/New, target Gender etc.);
Various universal identifiers (such as VIN, UPC, ISBN, etc.);
Brand of the product in the page;
Model of the product in the page; and
Address/location where the item is located.

Processors 106 then extract the above-mentioned key attributes from the page and perform various transformation operations on the resulting data. For example, one transformation involves converting a price into a price range and other numeric measures into numeric ranges to enable inclusion of a broader range of items from the Internet that the user probably should be considering. Another transformation includes determining the category of the page, for example whether the product being described in the page is a car, a job, an apartment, a TV, a garment, a chair, etc.

A search query is then formulated (210), and an Internet search performed (212) using the query. When search results are received, the processors 106 edit the results to eliminate results that are not similar to the current web page. In an embodiment pages having a different category than the determined category, having different units of measurements, having price that differs by more than a predetermined maximum amount, etc. In an embodiment (not shown) the results are sorted either by price, or by pages having the most matching attributes to the current page.

The edited results are then presented (216) to the user in their browser 105 either in an overlay on the currently viewed page, in a new window, or in a new tab.

FIG. 2B is a flow diagram illustrating a web page search process executed by the processors 106 according to an embodiment. This process is similar to the process of FIG. 2A, but the browser app 104 is automatically activated when the current web page is loaded in the web browser 105.

FIG. 2C is a flow diagram illustrating a web page search process executed by the processors 106 according to an embodiment. This process is similar to the process of FIG. 2A, but the user is accessing the Internet using a custom web browser 104A. Each time the user visits a web page (202), the processors 106 are requested to analyze (206) the web page.

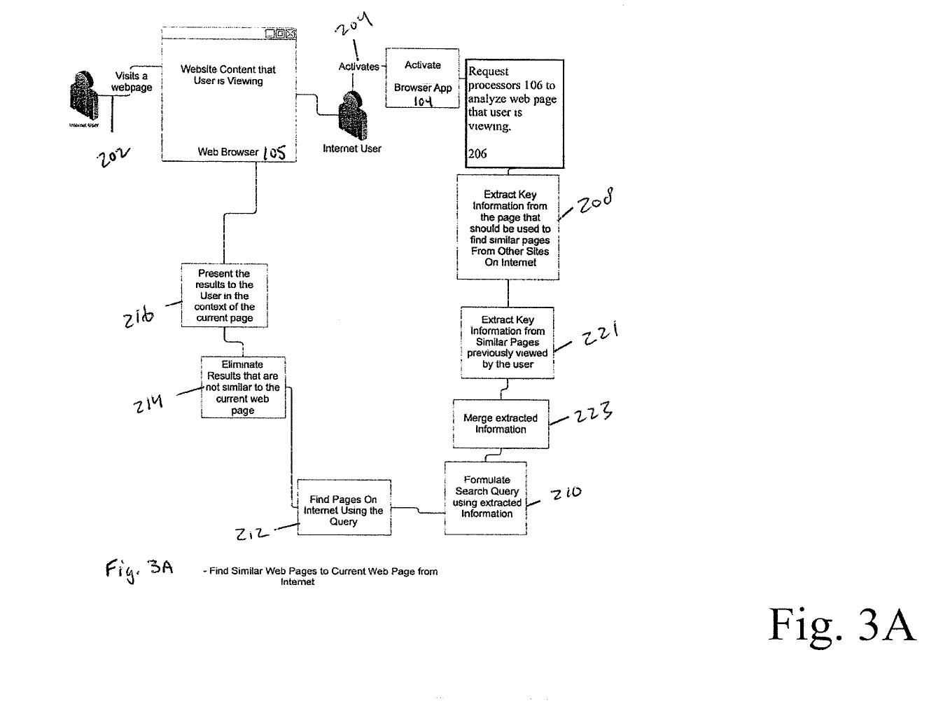

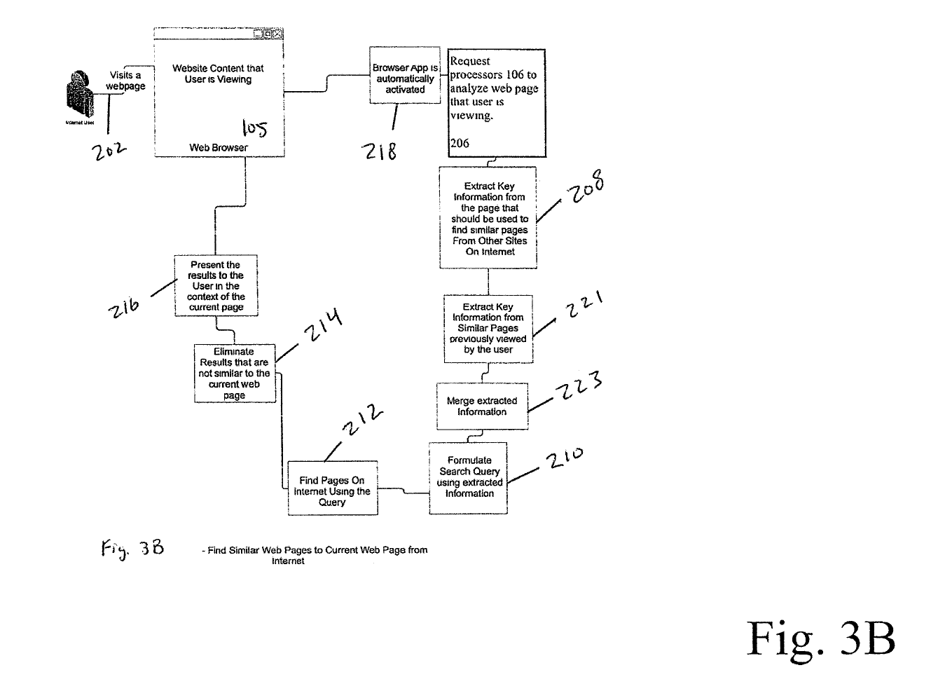

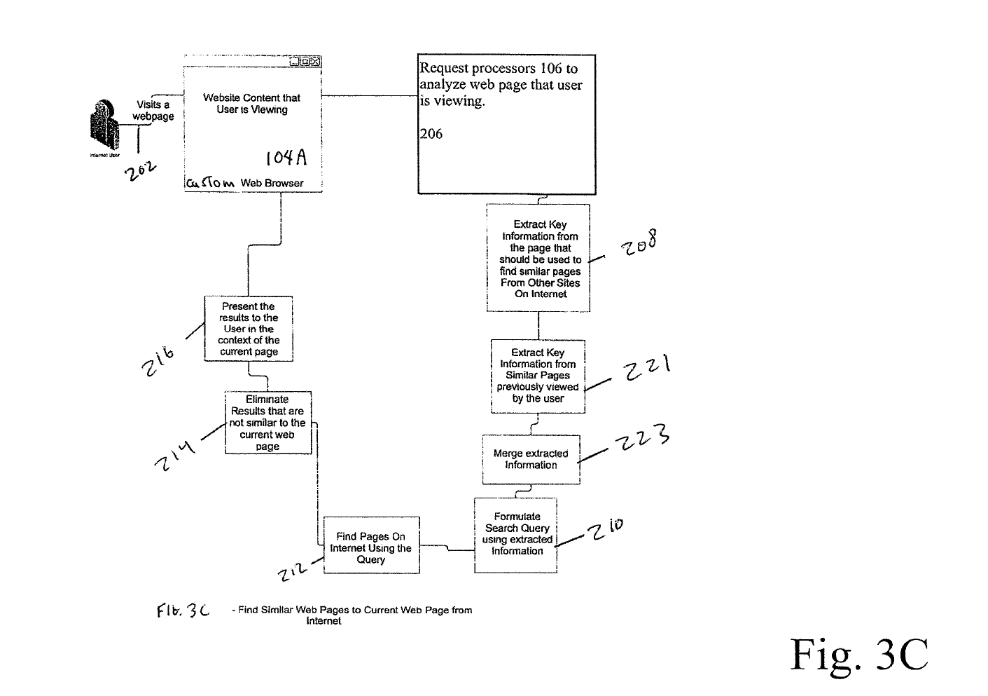

FIG. 3A is a flow diagram illustrating a web page search process executed by the processors 106 according to an embodiment. In this embodiment, previous browsing history is taken into account in finding similar pages from the Internet. Key attributes from the current page are extracted (as in the process of FIG. 2A) and in addition similar attributes are extracted from other pages that user has viewed that were similar to current page and those attributes are merged with current attributes to formulate a search query.

At 202, the user is logged onto the Internet and using a web browser 105. When the user activates (204) the browser app 104, the browser app 104 automatically submits either the URL of the current web page or the contents of the current web page with a request for processors 106 to analyze the web page (206). Processors 106 extract (208) key data for the web page, where the information is used to finding similar pages from other (and possibly the same) sites on the Internet. This involves the processors 106 analyzing the web page, including include analyzing the textual content of the page, analyzing the visual layout (such as position and size of various elements in the page) to find key elements that describe the item being shown on the page.

At 221, key data is extracted from similar web pages previously viewed by the user. At 223 the extracted data (information) from the current web page and the similar previous web page(s) is merged. Then the process continues as it does in FIG. 2A.

FIG. 3B is a flow diagram illustrating a web page search process executed by the processors 106 according to an embodiment. This process is similar to the process of FIG. 3A, but the browser app 104 is automatically activated when the current web page is loaded in the web browser 105.

FIG. 3C is a flow diagram illustrating a web page search process executed by the processors 106 according to an embodiment. This process is similar to the process of FIG. 3A, but the user is accessing the Internet using a custom web browser 104A. Each time the user visits a web page (202), the processors 106 are requested to analyze (206) the web page.

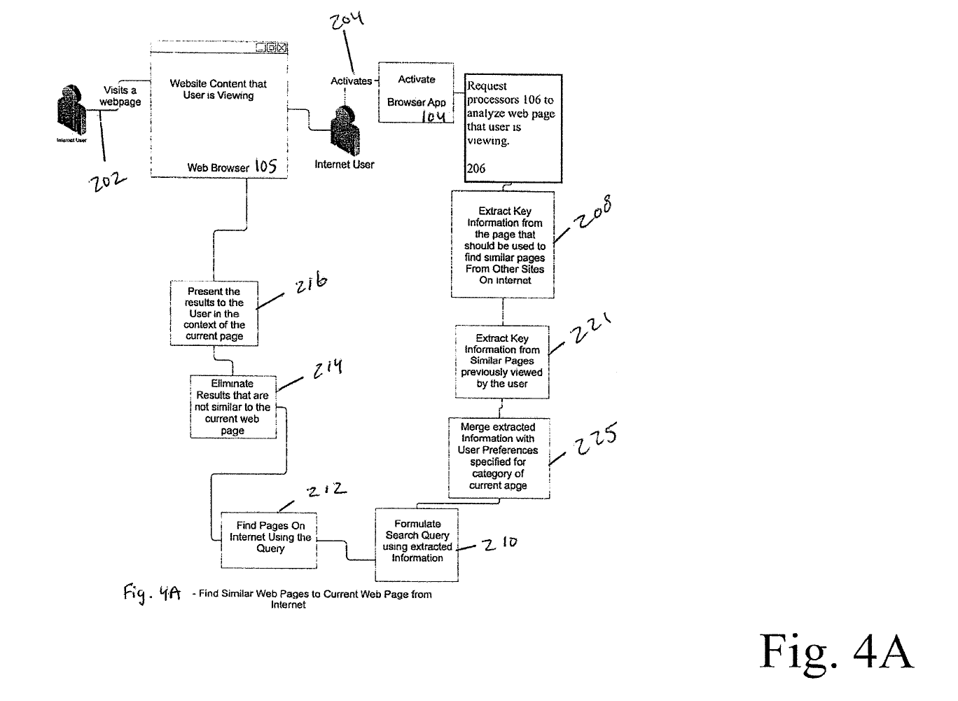

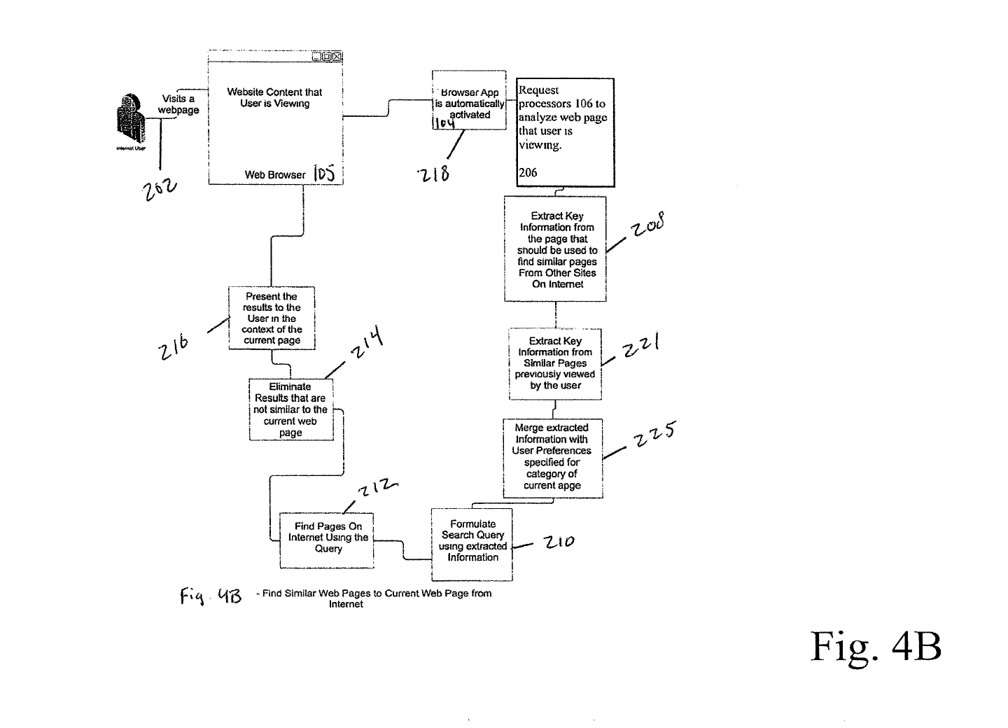

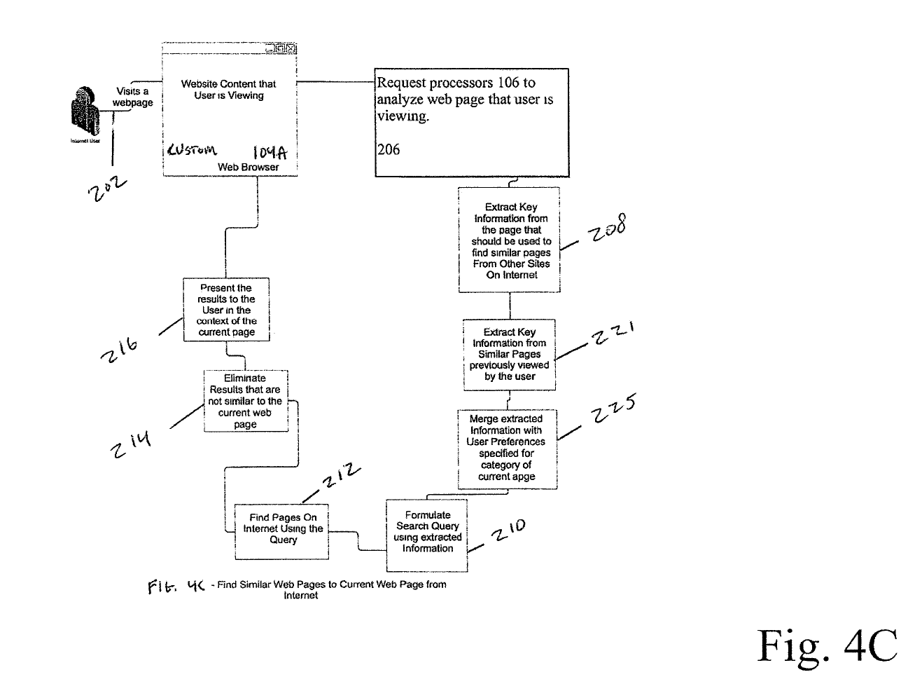

FIG. 4A is a flow diagram illustrating a web page search process executed by the processors 106 according to an embodiment. In this embodiment not only the current page and browser history are taken into account, but the preferences explicitly specified by the user via a user interface are also merged with the extracted information to formulate a query to find similar pages from the Internet which are similar to current page and the user specified preferences such as price-range, specific keywords that the page must contain, specific keywords that the user must not contain and ranges of other numeric measures associated with the category of the current page. For example, a user viewing a house with 3 bedrooms and 2 bath costing $400,000 might have specified a preference that the he or she is interested in houses between $300,000 and $500,000 with 3 to 4 bedrooms and key words saying he/she wants a swimming pool in the house and a key word saying the house should not be a town-home. These preferences are merged into the extract attributes to formulate the query.

At 202, the user is logged onto the Internet and using a web browser 105. When the user activates (204) the browser app 104, the browser app 104 automatically submits either the URL of the current web page or the contents of the current web page with a request for processors 106 to analyze the web page (206). Processors 106 extract (208) key data for the web page, where the information is used to finding similar pages from other (and possibly the same) sites on the Internet. This involves the processors 106 analyzing the web page, including include analyzing the textual content of the page, analyzing the visual layout (such as position and size of various elements in the page) to find key elements that describe the item being shown on the page. At 221, key data is extracted from similar web pages previously viewed by the user. At 225 the extracted data (information) from the current web page is merged with user preferences for the category of the current page. A search query is formulated in a syntax appropriate to one or more third party search engines. Then the process continues as it does in FIG. 2A.

FIG. 4B is a flow diagram illustrating a web page search process executed by the processors 106 according to an embodiment. This process is similar to the process of FIG. 4A, but the browser app 104 is automatically activated when the current web page is loaded in the web browser 105.

FIG. 4C is a flow diagram illustrating a web page search process executed by the processors 106 according to an embodiment. This process is similar to the process of FIG. 4A, but the user is accessing the Internet using a custom web browser 104A. Each time the user visits a web page (202), the processors 106 are requested to analyze (206) the web page.

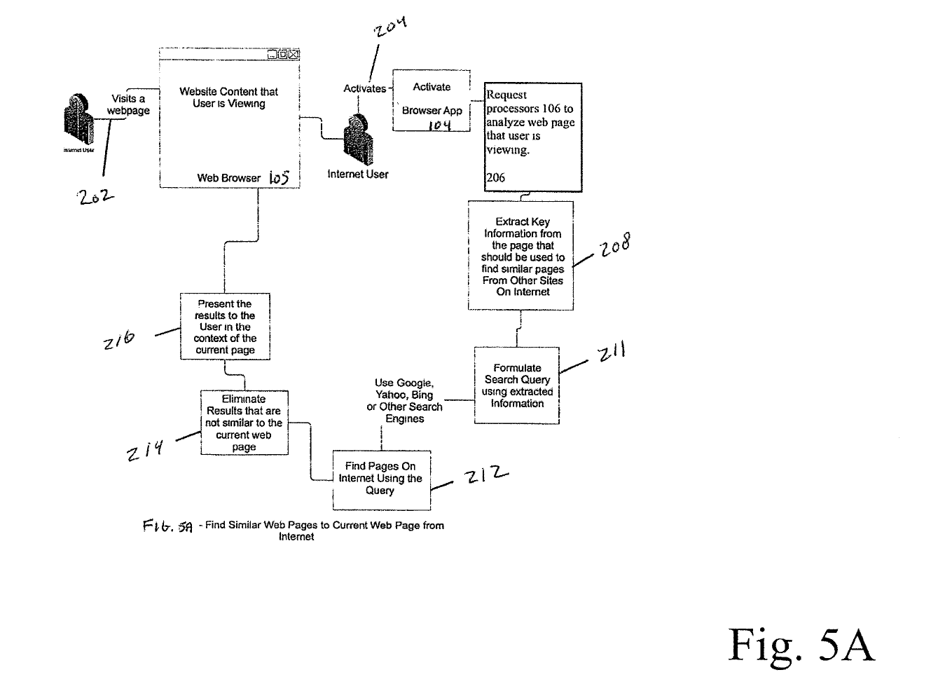

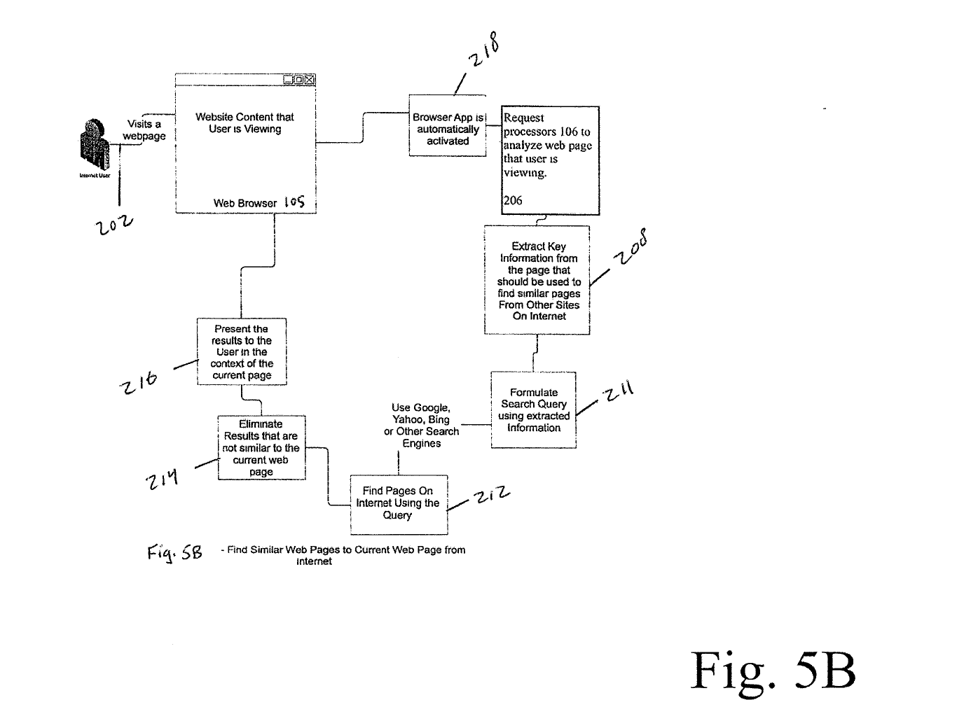

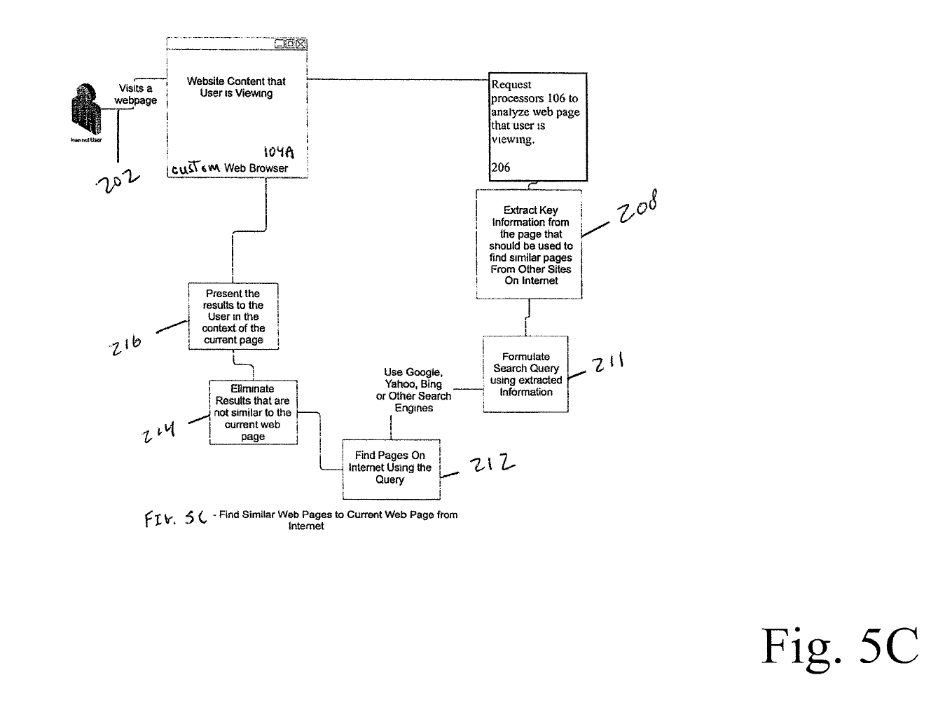

FIG. 5A is a flow diagram illustrating a web page search process executed by the processors 106 according to an embodiment in which third party search engines are used to perform the actual search, and the search query is built in the syntax of the respective third part search engine. At 202, the user is logged onto the Internet and using a web browser 105. When the user activates (204) the browser app 104, the browser app 104 automatically submits either the URL of the current web page or the contents of the current web page with a request for processors 106 to analyze the web page (206). Processors 106 extract (208) key data for the web page, where the information is used to finding similar pages from other (and possibly the same) sites on the Internet. This involves the processors 106 analyzing the web page, including include analyzing the textual content of the page, analyzing the visual layout (such as position and size of various elements in the page) to find key elements that describe the item being shown on the page.

Processors 106 then extract the above-mentioned key attributes from the page and perform various transformation operations on the resulting data. For example, one transformation involves converting a price into a price range and other numeric measures into numeric ranges to enable inclusion of a broader range of items from the Internet that the user probably should be considering. Another transformation includes determining the category of the page, for example whether the product being described in the page is a car, a job, an apartment, a TV, a garment, a chair, etc.

A search query is then formulated (211) in the syntax of one or more third party search engines, and an Internet search performed (212) using the query. When search results are received, the processors 106 edit the results to eliminate results that are not similar to the current web page. In an embodiment pages having a different category than the determined category, having different units of measurements, having price that differs by more than a predetermined maximum amount, etc. In an embodiment (not shown) the results are sorted either by price, or by pages having the most matching attributes to the current page.

The edited results are then presented (216) to the user in their browser 105 either in an overlay on the currently viewed page, in a new window, or in a new tab.

FIG. 5B is a flow diagram illustrating a web page search process executed by the processors 106 according to an embodiment. This process is similar to the process of FIG. 5A, but the browser app 104 is automatically activated when the current web page is loaded in the web browser 105.

FIG. 5C is a flow diagram illustrating a web page search process executed by the processors 106 according to an embodiment. This process is similar to the process of FIG. 5A, but the user is accessing the Internet using a custom web browser 104A. Each time the user visits a web page (202), the processors 106 are requested to analyze (206) the web page.

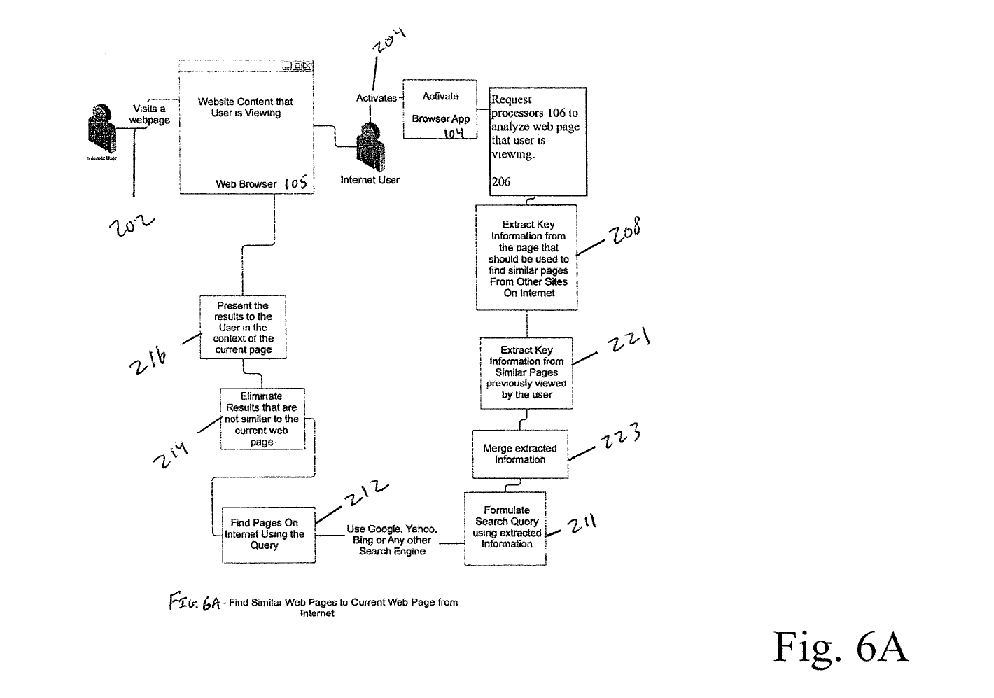

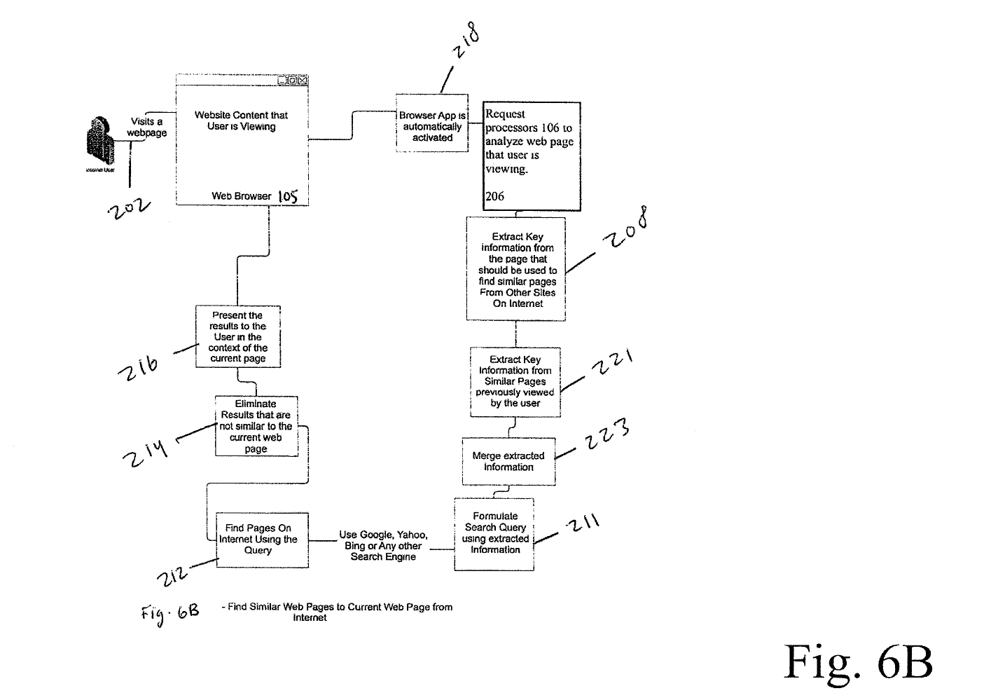

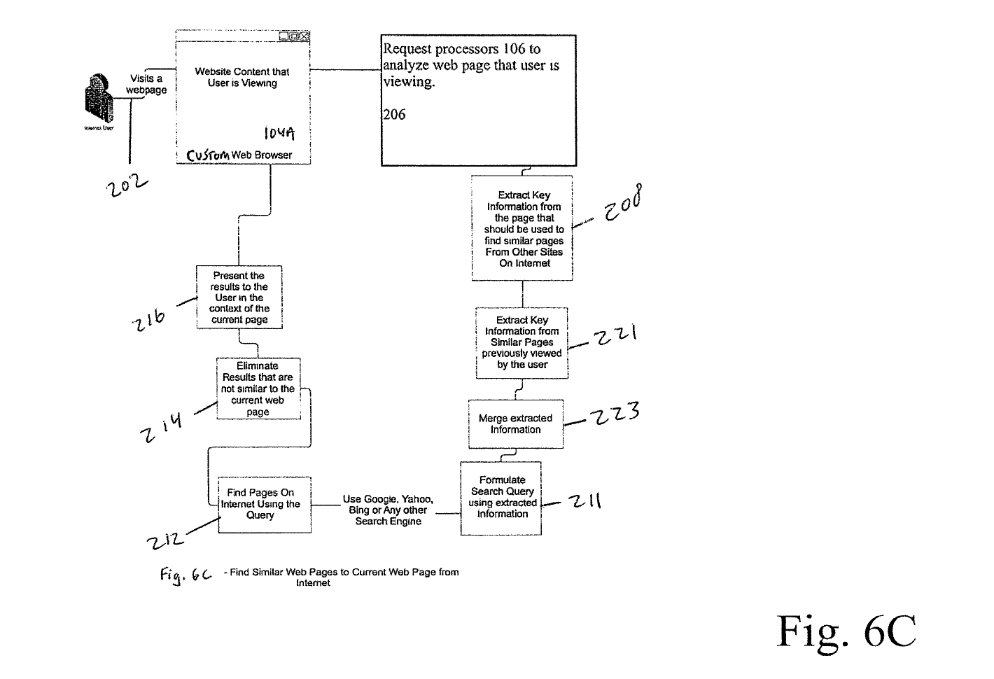

FIG. 6A is a flow diagram illustrating a web page search process executed by the processors 106 according to an embodiment in which the previous browsing history is also taken into account to formulate a query to be used with third party search engines to find similar pages. Key attributes from the current page are extracted (as in the process of FIG. 2A) and in addition similar attributes are extracted from other pages that user has viewed that were similar to current page and those attributes are merged with current attributes to formulate a search query.

At 202, the user is logged onto the Internet and using a web browser 105. When the user activates (204) the browser app 104, the browser app 104 automatically submits either the URL of the current web page or the contents of the current web page with a request for processors 106 to analyze the web page (206). Processors 106 extract (208) key data for the web page, where the information is used to finding similar pages from other (and possibly the same) sites on the Internet. This involves the processors 106 analyzing the web page, including include analyzing the textual content of the page, analyzing the visual layout (such as position and size of various elements in the page) to find key elements that describe the item being shown on the page.

At 221, key data is extracted from similar web pages previously viewed by the user. At 223 the extracted data (information) from the current web page and the similar previous web page(s) is merged. A search query is then formulated (211) in one or more syntaxes appropriate to one or more third party search engines. Then the process continues as it does in FIG. 2A.

FIG. 6B is a flow diagram illustrating a web page search process executed by the processors 106 according to an embodiment. This process is similar to the process of FIG. 6A, but the browser app 104 is automatically activated when the current web page is loaded in the web browser 105.

FIG. 6C is a flow diagram illustrating a web page search process executed by the processors 106 according to an embodiment. This process is similar to the process of FIG. 6A, but the user is accessing the Internet using a custom web browser 104A. Each time the user visits a web page (202), the processors 106 are requested to analyze (206) the web page.

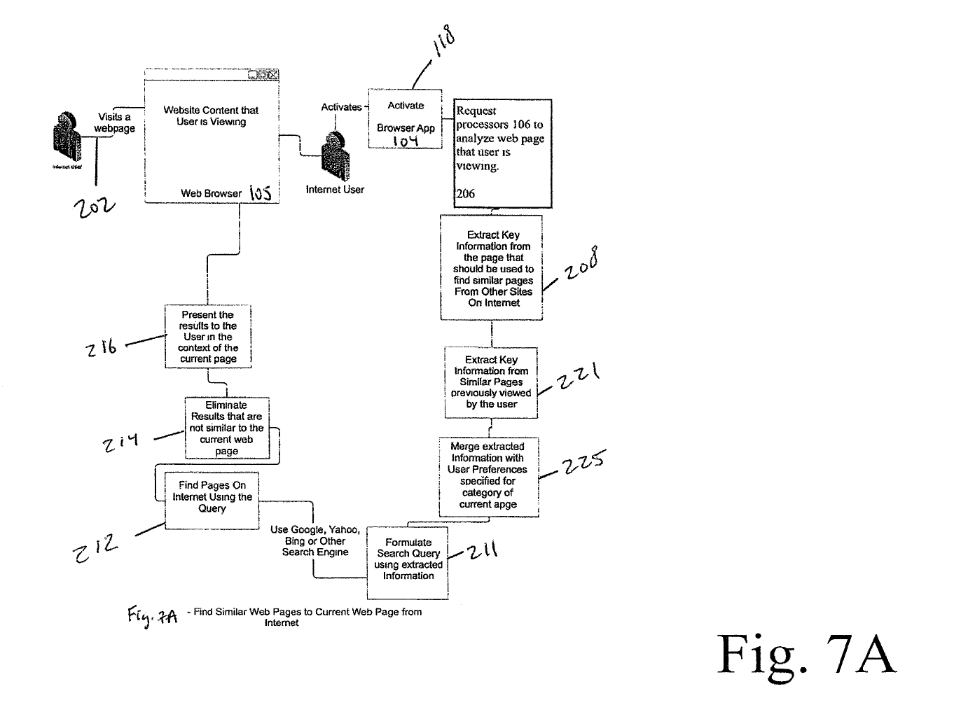

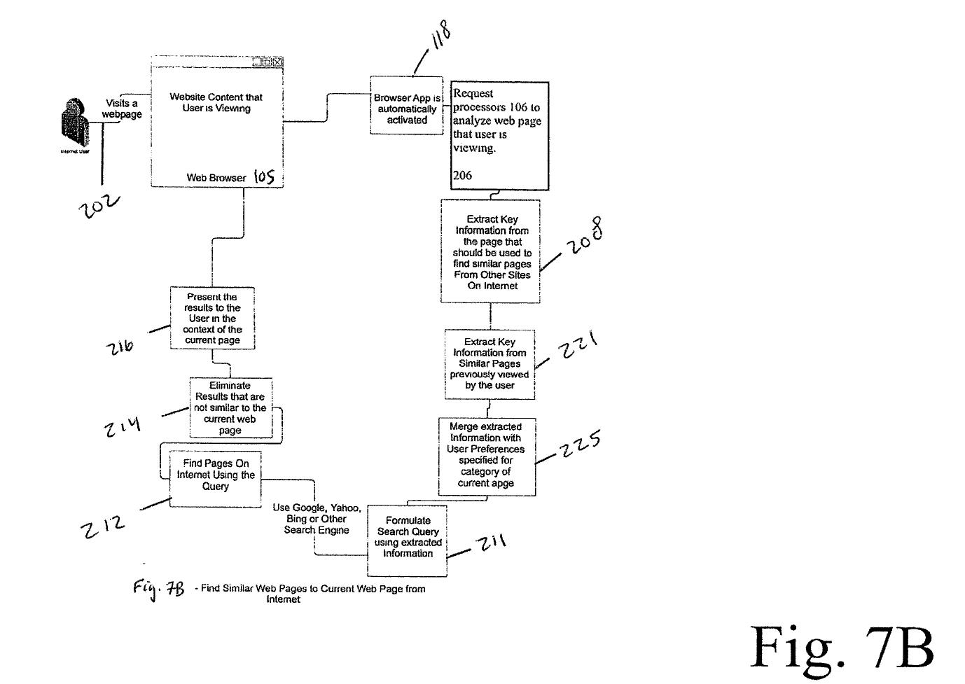

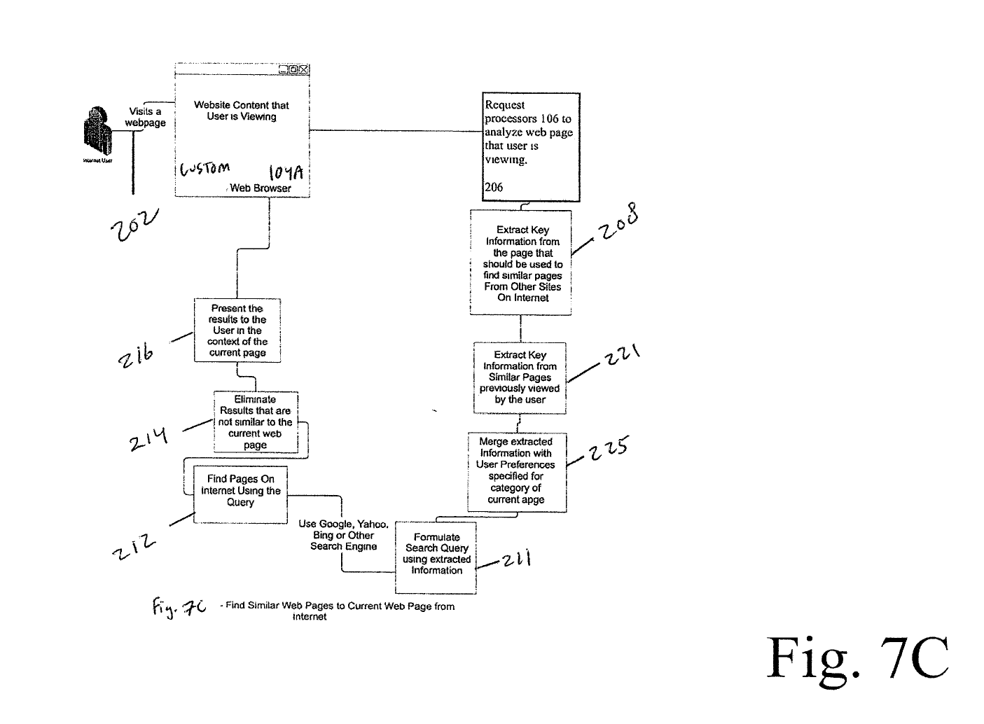

FIG. 7A is a flow diagram illustrating a web page search process executed by the processors 106 according to an embodiment. In this embodiment not only the current page and browser history are taken into account, but the preferences explicitly specified by the user via a user interface are also merged with the extracted information to formulate a query to find similar pages from the Internet which are similar to current page and the user specified preferences such as price-range, specific keywords that the page must contain, specific keywords that the user must not contain and ranges of other numeric measures associated with the category of the current page. For example, a user viewing a house with 3 bedrooms and 2 bath costing $400,000 might have specified a preference that the he or she is interested in houses between $300,000 and $500,000 with 3 to 4 bedrooms and key words saying he/she wants a swimming pool in the house and a key word saying the house should not be a town-home. These preferences are merged into the extract attributes to formulate the query.

At 202, the user is logged onto the Internet and using a web browser 105. When the user activates (204) the browser app 104, the browser app 104 automatically submits either the URL of the current web page or the contents of the current web page with a request for processors 106 to analyze the web page (206). Processors 106 extract (208) key data for the web page, where the information is used to finding similar pages from other (and possibly the same) sites on the Internet. This involves the processors 106 analyzing the web page, including include analyzing the textual content of the page, analyzing the visual layout (such as position and size of various elements in the page) to find key elements that describe the item being shown on the page. At 221, key data is extracted from similar web pages previously viewed by the user. At 225 the extracted data (information) from the current web page is merged with user preferences for the category of the current page. A search query is formulated in a syntax appropriate to one or more third party search engines. Then the process continues as it does in FIG. 2A.

FIG. 7B is a flow diagram illustrating a web page search process executed by the processors 106 according to an embodiment. This process is similar to the process of FIG. 7A, but the browser app 104 is automatically activated when the current web page is loaded in the web browser 105.

FIG. 7C is a flow diagram illustrating a web page search process executed by the processors 106 according to an embodiment. This process is similar to the process of FIG. 7A, but the user is accessing the Internet using a custom web browser 104A. Each time the user visits a web page (202), the processors 106 are requested to analyze (206) the web page.

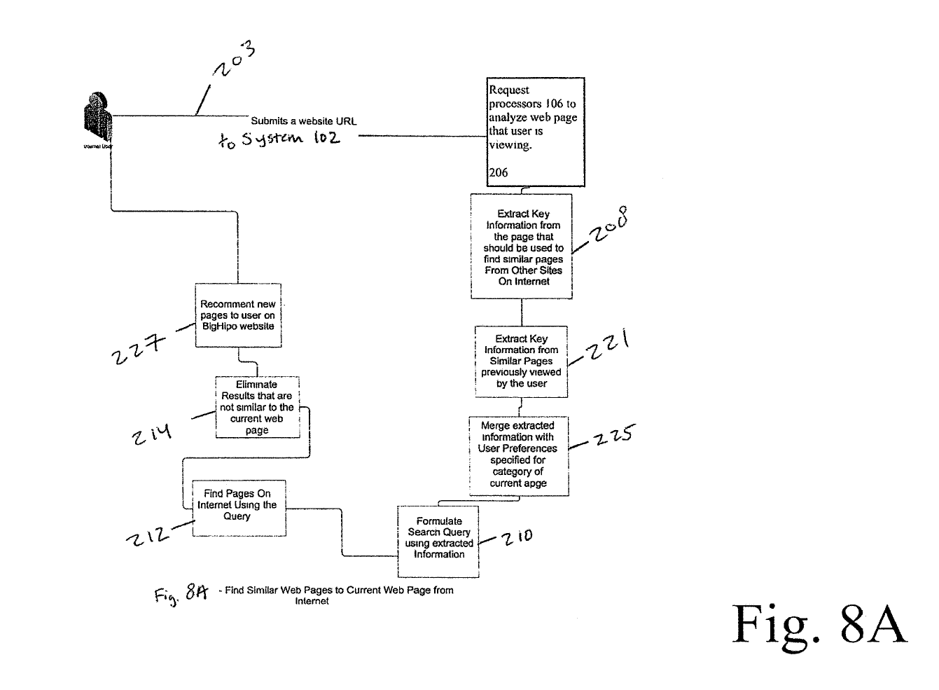

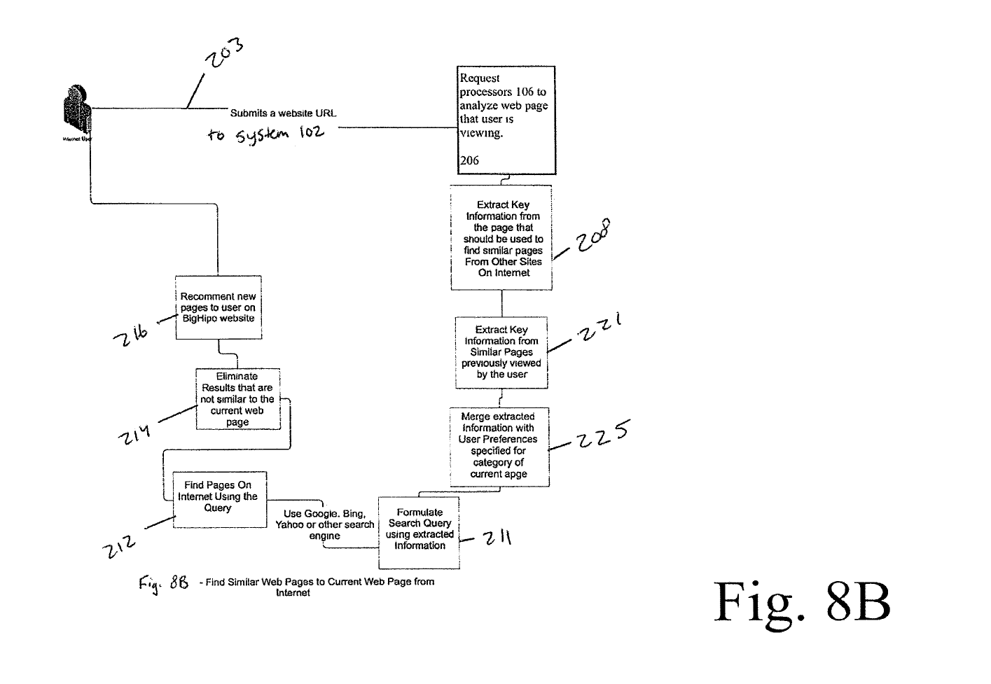

FIG. 8A is a flow diagram illustrating a web page search process executed by the processors 106 according to an embodiment in which a user submits a page to the system 102 website directly instead of using a browser app. In an embodiment, the same algorithms described above are executed to extract attributes from the submitted page, take into account previously added pages and specified user preferences to find of interest to the user. At 202, the user is logged onto the Internet and submits (203) a web site URL to system 102. Receipt of the URL also requests processors 106 to analyze the web page (206). Processors 106 extract (208) key data for the web page, where the information is used to finding similar pages from other (and possibly the same) sites on the Internet. This involves the processors 106 analyzing the web page, including include analyzing the textual content of the page, analyzing the visual layout (such as position and size of various elements in the page) to find key elements that describe the item being shown on the page. At 221, key data is extracted from similar web pages previously viewed by the user. At 225 the extracted data (information) from the current web page is merged with user preferences for the category of the current page. Then the process continues as it does in FIG. 2A.

FIG. 8B is a flow diagram illustrating a another web page search process executed by the processors 106 according to an embodiment in which a user submits a page to the system 102 website directly instead of using a browser app. In this embodiment, third party search engines are used to perform the web search. At 202, the user is logged onto the Internet and submits (203) a web site URL to system 102. Receipt of the URL also requests processors 106 to analyze the web page (206). Processors 106 extract (208) key data for the web page, where the information is used to finding similar pages from other (and possibly the same) sites on the Internet. This involves the processors 106 analyzing the web page, including include analyzing the textual content of the page, analyzing the visual layout (such as position and size of various elements in the page) to find key elements that describe the item being shown on the page. At 221, key data is extracted from similar web pages previously viewed by the user. At 225 the extracted data (information) from the current web page is merged with user preferences for the category of the current page. A search query is formulated in a syntax appropriate to one or more third party search engines. Then the process continues as it does in FIG. 2A.

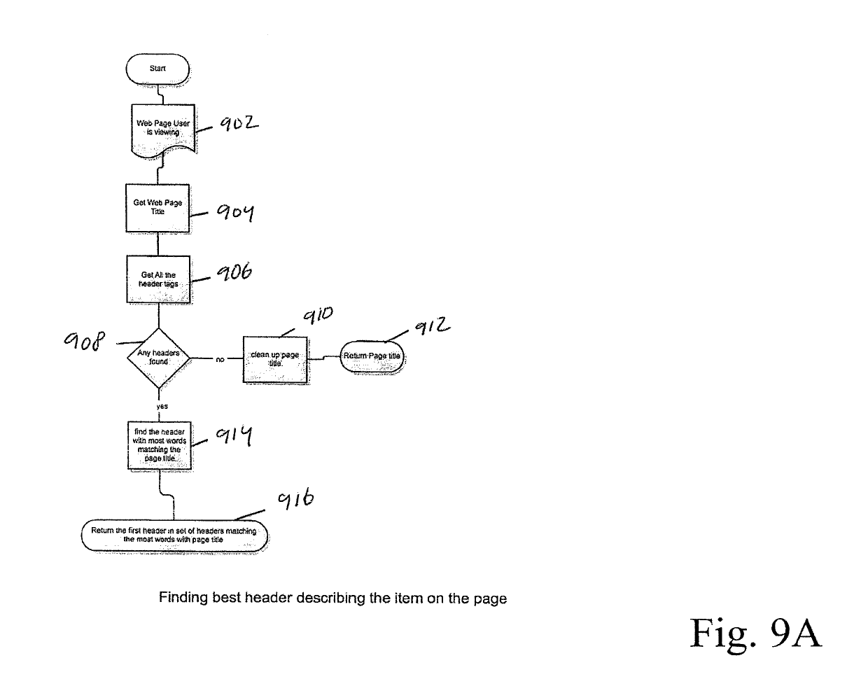

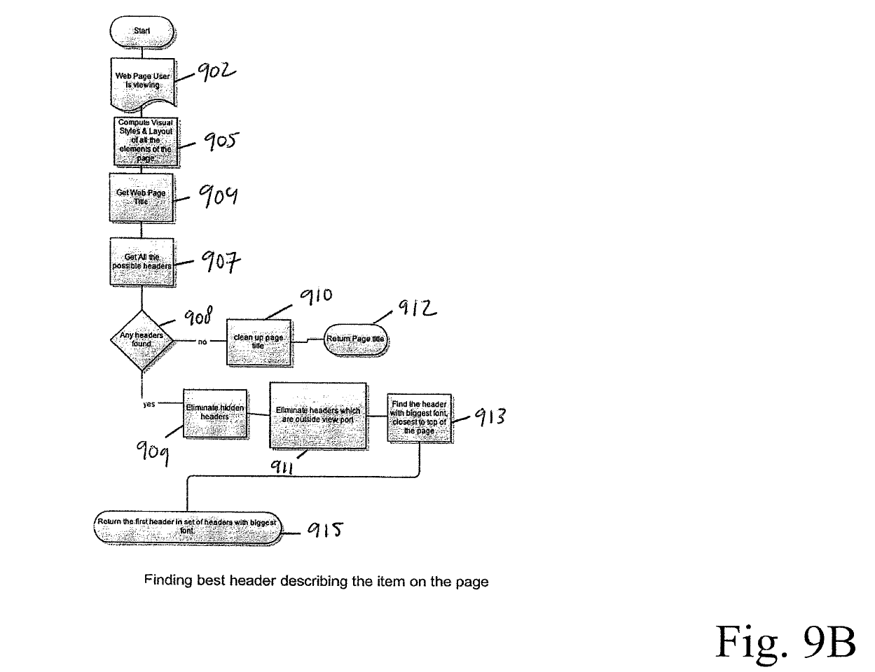

FIG. 9A is a flow diagram of a process for finding the title in the page that best describes the item under consideration. Most web pages have many header tags in a page and it is desirable to determine the header that most accurately describes the item so that information can be used in formulating an accurate search query to find similar pages. When the user is viewing a web page (902), the processors 106 find (904) the web page title (title of the web page itself). Then the processors 106 extract all the header tags and their contents from the page (906). A determination is made whether any headers were found at 908. If no headers were found, the page title is cleaned up (910) and returns (912) as the title.

If one or more headers were found, the headers with the most words matching the web page title are found (914) and placed in a set. The first header in the list of headers matching the most words with the web page title is returned at 916.

FIG. 9B is a flow diagram of another process for the finding title in the page that best describes the item under consideration. According to this embodiment, size of the header is used to determine relevance rather than words that match the title page. When the user is viewing a web page (902), the processors 106 compute (905) the visual styles and layout of all of the elements of the page. Then, the web page title is obtained (904). At 907, all possible headers for the page are obtained. A determination is made whether any headers were found at 908. If no headers were found, the page title is cleaned up (910) and returns (912) as the title.

If one or more headers were found, hidden headers are eliminated at 909. Headers outside of the view port are eliminated (911). Then the headers with the biggest font and closest to the top of the page are found at 913. The first header in the set of headers with the biggest font is returned at 916.

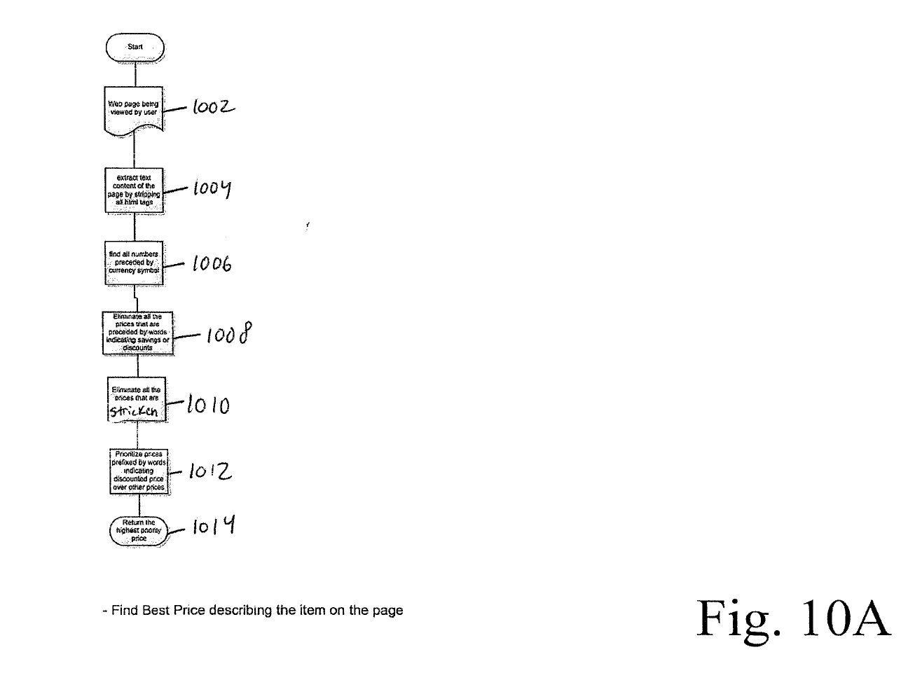

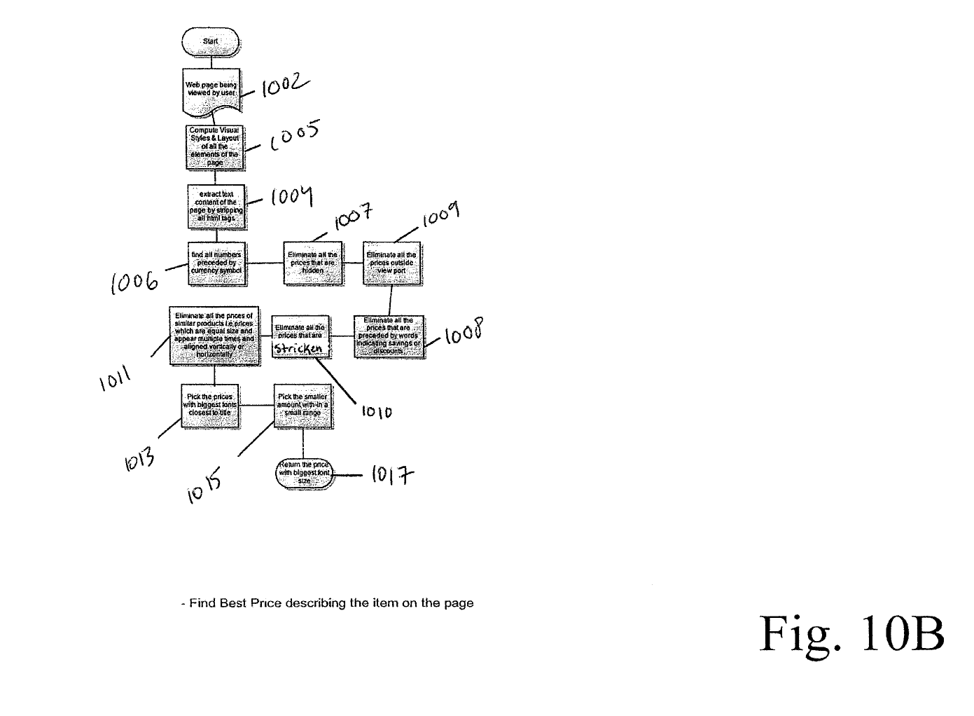

FIG. 10A is a flow diagram describing a method of finding a best price on a web page according to an embodiment. Most web pages that have products for sale have several prices listed on the page. For example, we pages can list regular price, offered price, market price, competition price, savings etc., along with listing similar products and the prices for those. The described algorithm finds the most accurate price for the product from all the prices listed so that it can be used for formulating a query.

When a user is viewing a web page (1002), the processors 106 first strip out all the html tags in the page, leaving only text (1004). Next, all numbers preceded by a currency symbol are found (1006). At 1008, all the currency-number combinations that are preceded by keywords identified as keywords describing discounts, competition price, market price, previous price, list price etc. are eliminated. All the currency-number combination that are stricken via presentation styles are also eliminated (1010).

The remaining prices are then prioritized (1012). Prices prefixed or suffixed by words indicating discounted price, sale price, special price, buy now price, interne price etc. are given higher priority. The price with highest priority is returned at 1014.

In yet another embodiment, if prices do not have prefixes, the price found closest to the item title in the document is returned.

FIG. 10B s is a flow diagram describing a method of finding a best price on a web page according to an embodiment where the font size and visibility of the price is given priority. When a user is viewing a web page (1002), the processors 106 first compute the visual styles and layouts of all of the elements of the web page (1005). Then processor 106 strip out all the html tags in the page, leaving only text (1004). Next, all numbers preceded by a currency symbol are found (1006). At 1007, all hidden process are eliminated. At 1009 all prices outside the view port are eliminated. At 1008, all the currency-number combinations that are preceded by keywords identified as keywords describing discounts, competition price, market price, previous price, list price etc. are eliminated. All the currency-number combination that are stricken via presentation styles are also eliminated (1010). At 1011 all of the prices of similar products (such as prices which are equal size and appear multiple times and aligned vertically or horizontally) are eliminated. The prices with the biggest fonts are chosen at 1013, and the smaller amount within a small range is then chosen at 105. The remaining price with the biggest font size is returned at 1017.

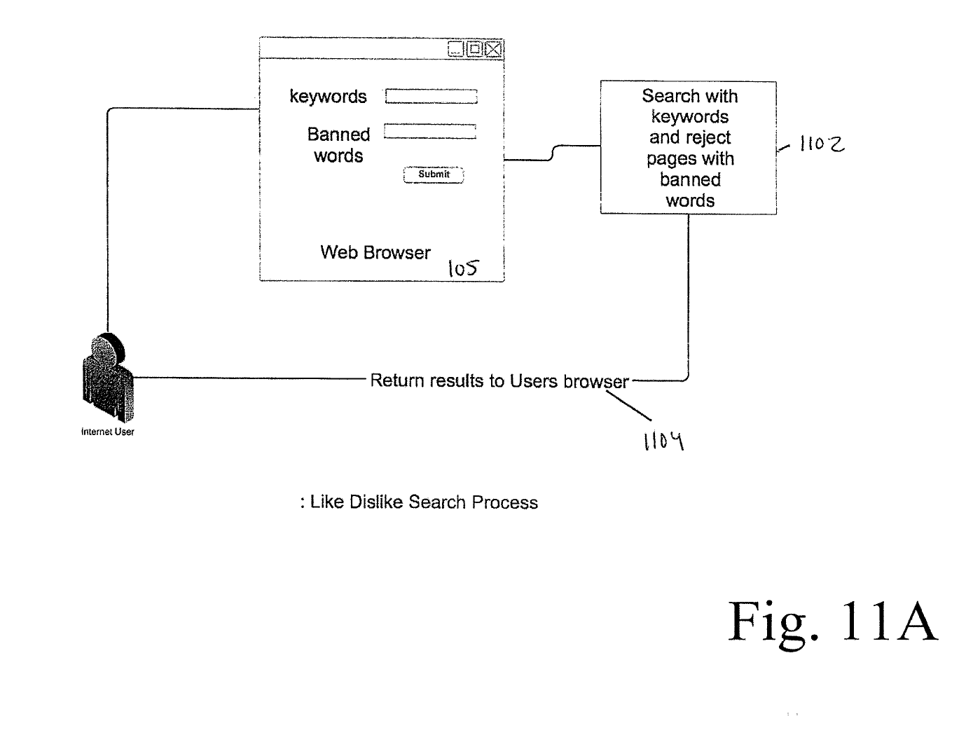

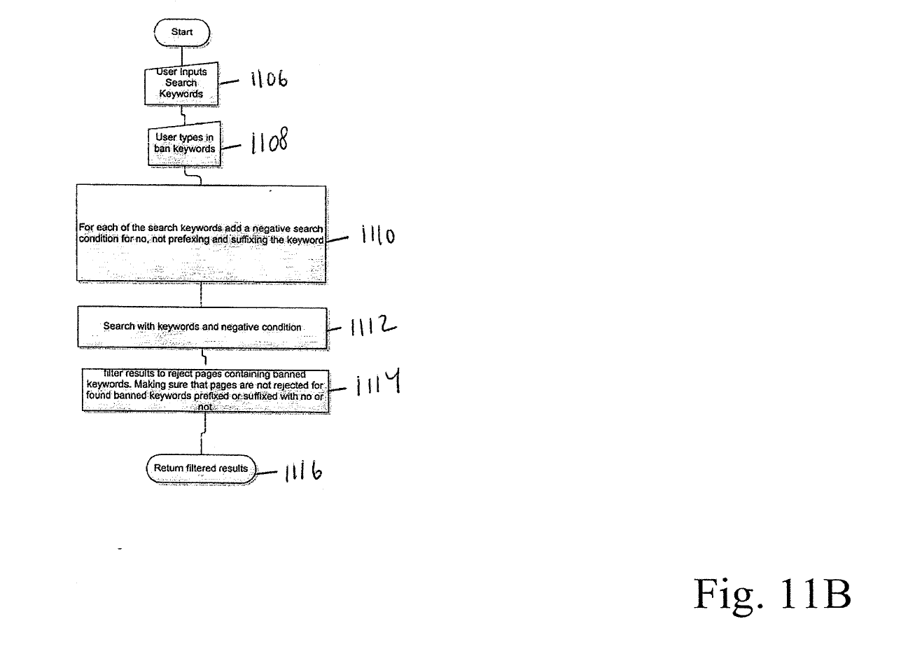

FIG. 11A is flow chart illustrating a like-dislike search process according to an embodiment. This embodiment uses desired keywords as well as banned keywords in the search process. All the search engine web browsers 105 present a search box to the user to enter keywords for searching. They also often present additional boxes for a user to qualify each keywords. For example, a box for name, another box for price-range and so on. Using these techniques for searches returns all the pages containing the keywords. In many situations users are looking for items with keywords but would not like to retrieve results that contained some other words. For example, a user searches for all food items that do not have sodium. Current search engines require the user to type in keywords and then a complex ‘not’ condition for sodium, which is difficult for unsophisticated users.

The user can easily indicate things or characteristics they dislike by enter keywords in a keyword box of the browser app 104A, and banned words in another box of the browser app 104 without user having to know complex query syntax. Then processors 106 formulate a search query to search (1102) keywords and reject pages with “banned” words. The results are returned (1104) to the web browser app 104A.

FIG. 11B is a flow diagram illustrating a method of yet another embodiment in which the system not only takes into account search keywords and banned keywords, but also looks for negative text in a document. For example, a document might have words like “warranty not available” or “no warranty” while the user is searching for an item with a warranty. The system expands the search query by including a condition, which says no or not should not prefix or suffix the keyword.

The user inputs search keywords at 1006, and inputs the banned keywords at 1008. For each of the search keywords, a negative search condition is added (1110) for no, not prefixing and suffixing the banned keyword. A search is performed (1112) with the keywords and the negative condition. The results of the search are filtered (1114) to reject pages containing banned keywords. A check is performed to make sure that no pages are rejected for found banned keywords prefixed or suffixed with no or not.

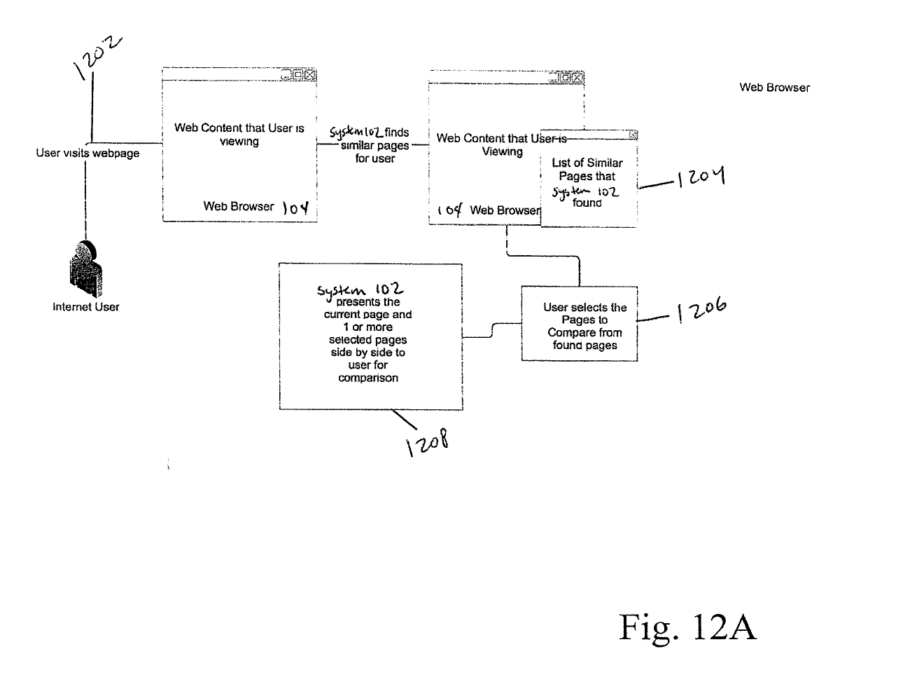

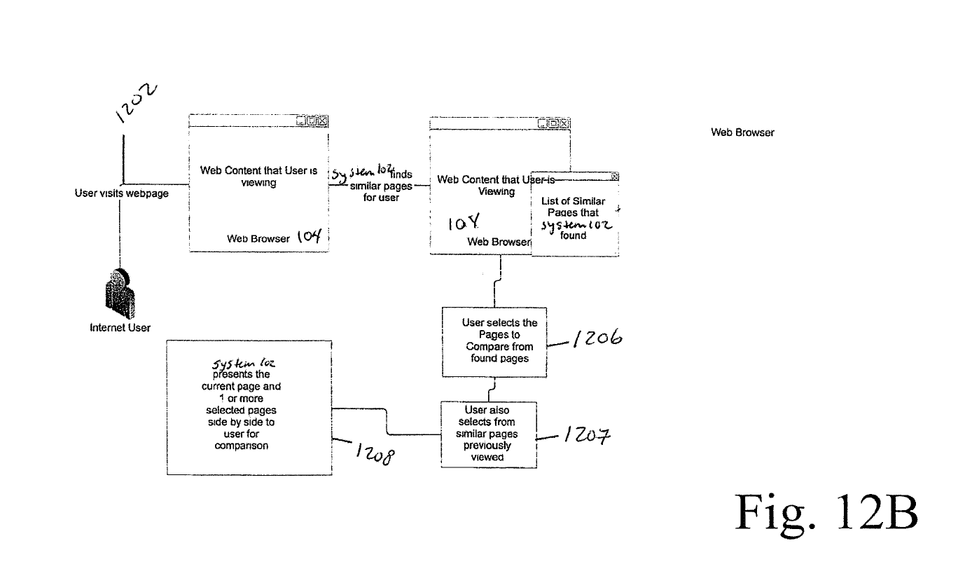

FIG. 12A is a flow diagram of a process according to another embodiment of the invention in which a user can compare the current web page that he or she is viewing side-by-side with other pages from the Internet that are similar to the current page. Similar pages show products, services, real-estate, jobs or any other item that is similar to the current page. In this embodiment the browser app 104 (or 104A) finds several pages from the Internet and then the user selects (1206) all the ones that are to be compared with the current page and the system shows these pages side-by-side for comparison (1208). The pages can be shown side-by-side in several ways: as automatically pop windows per page; each page framed into a section of an enclosing web page; or screen shot of each page shown into a section of an enclosing web page.

FIG. 12B is a flow diagram illustrating an embodiment in which the user can select from the pages found by the browser app 104 and in addition can select from a list of pages that they had viewed and were similar to the current page (1207).

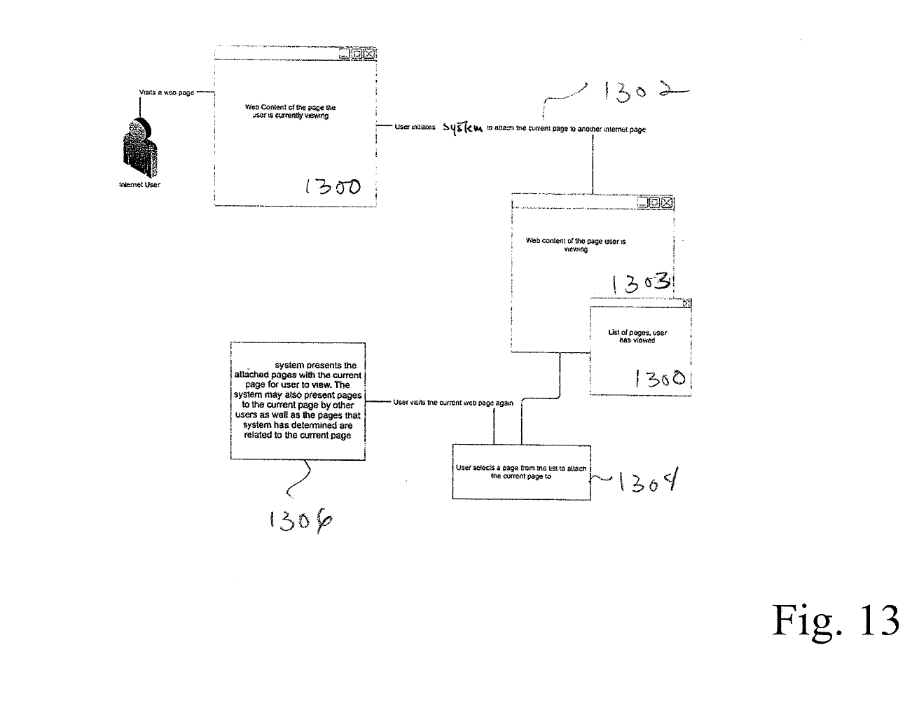

FIG. 13 is a flow diagram illustrating an embodiment of the invention in which a user can request the system 102 to attach web pages that they are viewing 1300 to other web pages 1303 on the Internet, and when any web page is viewed that has attachments, the system also presents attached pages to the user to view. These can be presented automatically by the system 102 when the web page 1303 is loaded, or upon user action such as clicking a button or doing swiping gesture or voice command. The attached pages 1303 that are presented to the user are the pages attached by the user (1304). Optionally they can also be pages attached by other users of the system (1306). The pages that are selected for presentation can also be automatically attached by the system. The system can attach those pages by detecting the category of the page, physical location of item on the page, and finding pages on Internet which are of related category of the page being viewed.

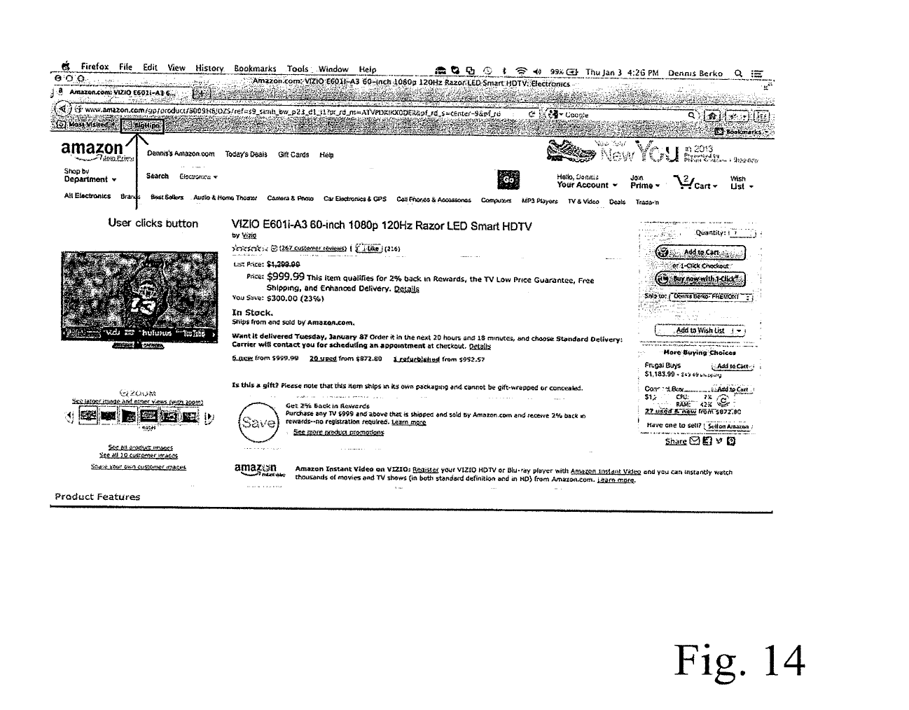

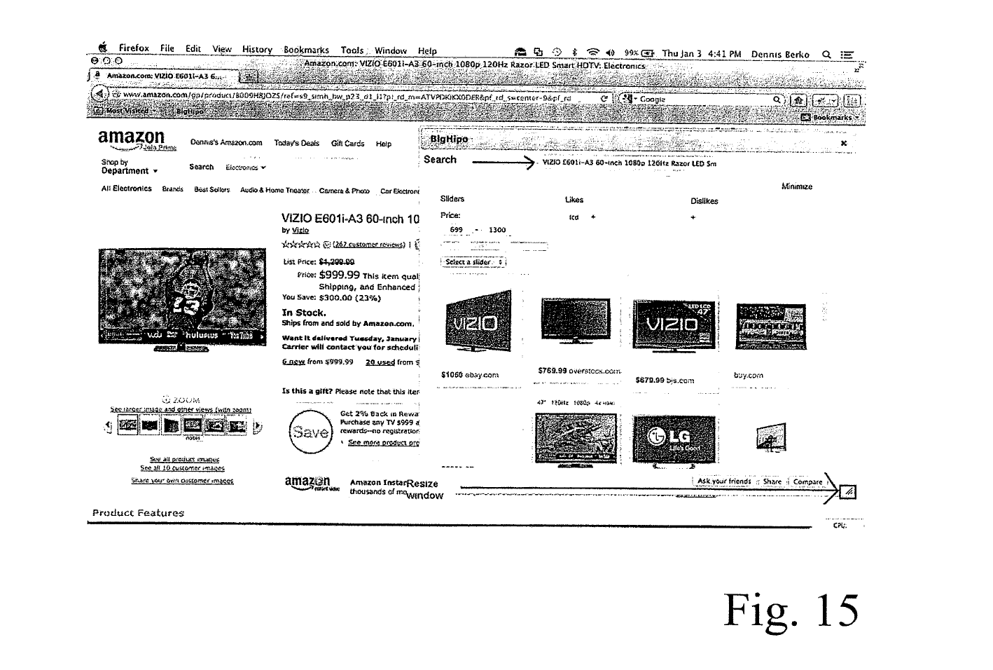

FIGS. 14-17 are screenshots that show an embodiment of a user interface displayed by the system 102. FIG. 14 shows a screen from the Amazon™ web site, which also displays a “BigHipo” button. In this example, BigHipo is a name given to the system and method claimed herein. Clicking the BigHipo button activates the system 102 to automatically find items similar to the items displayed on the original page. FIG. 15 shows the BigHipo window presenting products similar to the one that the user was viewing. The similar products are available from other sites on Internet that carry such product. It also shows how user can select pages from the Internet to compare with the current page.

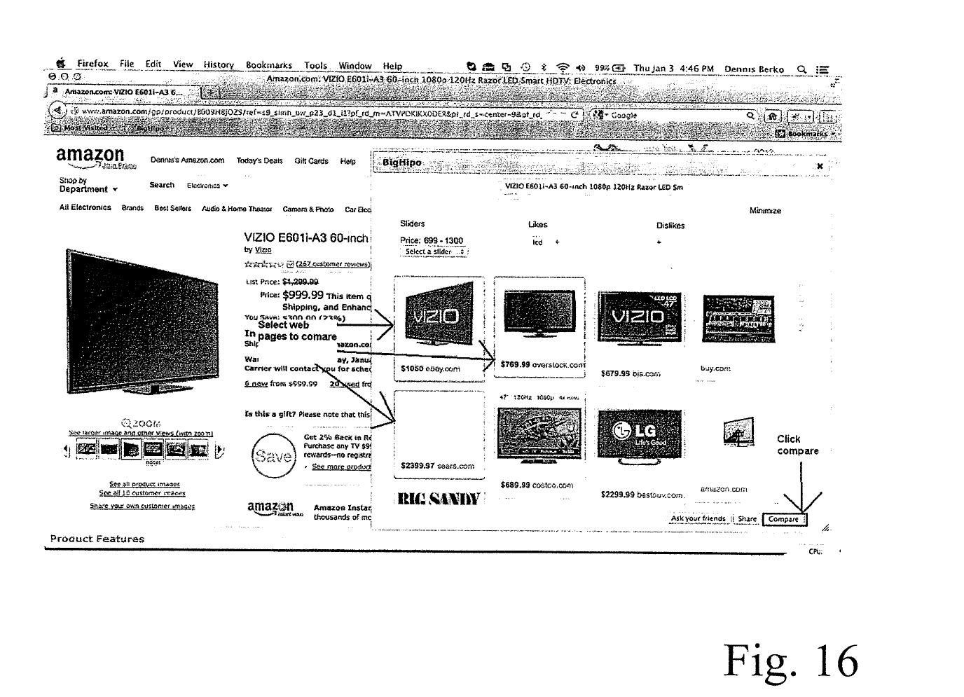

FIG. 16 shows a comparison view where the current page and one of the selected product are show together. In an embodiment, clicking on the right arrow brings the next page to view.

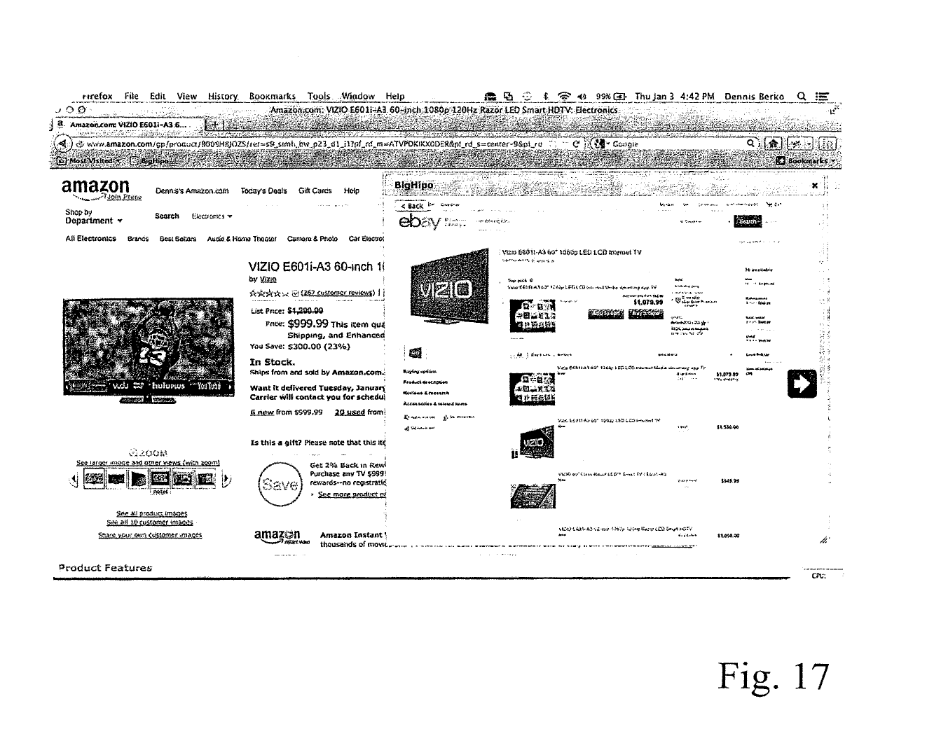

FIG. 17 shows the screen when one of the search results (eBay™) was chosen by the user to view overlaid on the original page.

In addition to the system and method described herein, novel business methods are practicable using the system and method. For example, it is possible for the system to participate in retargeting networks, as the users' current shopping become intimately than known. Also, participating retailers cab buy the opportunity to provide custom coupons and offers based on the items that users are currently searching for using the system. Businesses selling related items can be permitted to advertise their products in a related information section, e.g. a person searching for a home can view realtors and mortgage brokers' advertisements in a related information section.

Aggregated Internet usage patterns collected using the system can be sold to retailers. In addition, because the system gives an implicit co-op buying opportunity. For example, the system knows if 10 people add the same product to their list. Retailers offering the item can be approached and offered the 10 buyers at once for a fee or discount. Alternatively the price of the item can be negotiated based on bulk sale. Deals between retailers/manufacturers and consumers can be brokered based on the system's implicit co-op buying opportunity.

Advertising space can be sold in a system rewards consumption program where consumers can redeem rewards against discounts from various participating retailers.

Similar search methodologies to those described here can be offered as custom search tools or services for businesses who desire pricing and competition intelligence. These can also be offered to human resource departments for finding candidates automatically from a constant inflow of resumes.

The system and method are usable to enable businesses to provide always-on search within their network to help their users finding related pages very quickly. This can be used in searching through support tickets, product documentations, bug databases, corporate wikis. Businesses can be enabled to offer easier job search tools to potential candidates on their sites.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the system include: microcontrollers with memory (such as electronically erasable programmable read only memory (EEPROM)), embedded microprocessors, firmware, software, etc. Furthermore, aspects of the system may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that the various functions or processes disclosed herein may be described as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the internet and/or other computer networks via one or more data transfer protocols (e.g., HTTP, FTP, SMTP, etc.). When received within a computer system via one or more computer-readable media, such data and/or instruction-based expressions of components and/or processes under the system described may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the systems and methods is not intended to be exhaustive or to limit the systems and methods to the precise forms disclosed. While specific embodiments of, and examples for, the systems components and methods are described herein for illustrative purposes, various equivalent modifications are possible within the scope of the systems, components and methods, as those skilled in the relevant art will recognize. The teachings of the systems and methods provided herein can be applied to other processing systems and methods, not only for the systems and methods described above.

The elements and acts of the various embodiments described above can be combined to provide further embodiments. These and other changes can be made to the systems and methods in light of the above detailed description.

In general, in the following claims, the terms used should not be construed to limit the systems and methods to the specific embodiments disclosed in the specification and the claims, but should be construed to include all processing systems that operate under the claims. Accordingly, the systems and methods are not limited by the disclosure, but instead the scope of the systems and methods is to be determined entirely by the claims.

While certain aspects of the systems and methods are presented below in certain claim forms, the inventors contemplate the various aspects of the systems and methods in any number of claim forms. For example, while only one aspect of the systems and methods may be recited as embodied in machine-readable medium, other aspects may likewise be embodied in machine-readable medium. Accordingly, the inventors reserve the right to add additional claims after filing the application to pursue such additional claim forms for other aspects of the systems and methods.

What is claimed is:

1. A computer implemented method for aggregating web site information, the method comprising:
a processor extracting information from a current web page that is being viewed by a user;
the processor analyzing the extracted information;
the processor formulating an Internet query using the extracted information;
the processor executing the Internet query; and
the processor aggregating information from results of the query with the extracted information.

2. The method of claim 1, wherein the results of the query comprise one or more web pages, and wherein aggregating further comprises the processor aggregating the one or more web pages with the current web page.

3. The method of claim 2, further comprising making the one or more web pages available to the user.

4. The method of claim 3, further comprising:
the processor receiving a user input via a user interface, wherein the user input requests the processor to display a side-by-side comparison of the current web page with the one or more web pages; and
the processor displaying the side-by-side comparison in a web browser.

5. The method of claim 2, further comprising the processor storing a user search history in a database, wherein the user search history includes web pages aggregated according to search criteria.

6. The method of claim 1, further comprising:
the processor receiving user input via a user interface, wherein the user input comprises user preferences regarding items to be search for on the Internet; and
the processor using the user preferences in formulating the search query.

7. The method of claim 1, further comprising:
the processor receiving user input via a user interface, wherein the user input comprises an indication of another web page the user wishes to attach to the current web page;
in response to the user input, the processor linking the other web page to the current web page, wherein linking causes the other web page to be displayed when the user later references the current web page.

8. The method of claim 6, wherein the user preferences include disliked criteria and wherein the method further comprises formulating a search query that rejects web pages matching the disliked criteria.

9. The method of claim 1, further comprising the processor displaying a user interface that allows the user to interact with a system web browser application, and wherein executing the Internet query comprises using commercial search engines.

10. The method of claim 1, further comprising the processor displaying a user interface that allows the user to interact with a custom web browser, and wherein executing the Internet query comprises using a proprietary system search engine.

11. The method of claim 3, wherein making the one or more web pages available to the user comprises:
the processor automatically displaying the one or more web pages with the current web page; and
the processor receiving user input via a user interface to display the one or more web pages with the current web page.

12. The method of claim 1, further comprising:
the processor automatically memorizing web pages viewed by the user; and
the processor notifying the user when data of interest on a web page has changes, wherein data of interest comprises one or more of price and availability.

13. The method of claim 1, further comprising:
the processor receiving user input via a user interface, wherein the user input indicates an item on a web page that a user wishes to share with others;
in response to the user input, the processor notifying the others of the item;
the processor receiving data regarding the item from the others;
the processor aggregating the data regarding the item; and
the processor making the data regarding the item available to the user and to the others.

14. A system for web site information aggregation, comprising:
a processor configured to communicate with the Internet, and further configured to execute a web site information aggregation method;
a database for storing user information and web site information;
at least one user interface for receiving user input and for displaying results to a user, wherein the web site information aggregation method comprises,
the processor analyzing a current web page viewed by the user;
the processor extracting information from the current page;
the processor formulating a search query using the extracted information, wherein the search query is for finding web pages on the Internet that are similar to the current web page;
the processor executing the search query; and
the processor displaying the results of the search query to the user.

15. The system of claim 14, wherein the at least one user interface comprises a browser app.

16. The system of claim 14, wherein the at least one user interface comprises a custom web browser.

17. The system of claim 14, wherein executing the search query comprises the processor using commercial search engines.

18. The system of claim 14, wherein executing the search query comprises the processor using a proprietary search engine.

19. The system of claim 14, wherein the processor analyzes the current web page in response to user input activating a system browser app.

20. The system of claim 14, wherein the processor automatically analyzes the current web page.

21. The system of claim 14, wherein the web site information aggregation method further comprises aggregating the web page currently viewed and the similar web pages viewed by the user.

22. The system of claim 21, wherein the web site information aggregation method further comprises extracting information from the similar pages previously viewed by the user.

23. The system of claim 22, wherein the web site information aggregation method further comprises merging extracted information from the similar pages previously viewed by the user with extracted information from the current web page.

24. The system of claim 23, wherein formulating the search query comprises using the merged, extracted information.
